(19) United States
(12) Patent Application Publication
(10) Pub. No.: US 2011/0202411 A1
(43) Pub. Date: Aug. 18, 2011

(54) ADVERTISING VOICE CONTROL DEVICE, INTEGRATED CIRCUIT, ADVERTISING VOICE CONTROL METHOD, ADVERTISING VOICE CONTROL PROGRAM, AND RECORDING MEDIUM

(76) Inventors: Kentaro Nakai, Kanagawa (JP); Yoshikatsu Ito, Osaka (JP)

(21) Appl. No.: 13/123,954

(22) PCT Filed: Oct. 29, 2009
(86) PCT No.: PCT/JP2009/005719

§ 371 Date: Apr. 13, 2011

(30) Foreign Application Priority Data
Nov. 4, 2008 (JP) 2008-283204

(51) Int. Cl. G06Q 30/00

(52) U.S. Cl. 705/14.73

(57) ABSTRACT

A control terminal device 100 stores service applications and advertising applications in a storage unit 111. Each service application corresponds to one or more of the advertising applications. Each service application is also associated with a different one of home appliances 103 to 106. A control unit 112 of the control terminal device 100 causes the display device 101 to display the service applications corresponding to the respective home appliances. The control unit 112 also detects one advertising application corresponding to the service application that the user has focused on and clicked on by operating the remote control, by referring to the content stored in the storage unit 111. Then, the control unit 112 causes the display device 101 to output audio of an audio file corresponding to the detected advertising application.

### TECHNICAL FIELD

The present invention relates to a technique for controlling audio outputting advertisements in a plurality of advertisements.

### BACKGROUND ART

In recent years, personal computers display a plurality of advertisements on a display device, while outputting audio information relating to the advertisements (See Patent Literature 1, for example).

Also, when a user terminal accesses a web page playing back an advertisement with audio and displays the advertisement, the user terminal reproduces the audio of the advertisement (see Patent Literature 2, for example).

### CITATION LIST

### Patent Literature

[Patent Literature 1] Japanese patent application publication No. 2004-86120
[Patent Literature 2] Japanese patent application publication No. 2003-36386

### SUMMARY OF INVENTION

### Technical Problem

With the former prior technique mentioned above, however, the advertisements which attract the interest of a user are not necessarily the ones that output audio among the plurality of advertisements. Outputting audio for the advertisements that do not attract the interest of the user adversely gives the user a sense of discomfort, causing a risk of decreasing the advertising effectiveness. Furthermore, because of the absence of descriptions for controlling audio output for the plurality of advertisements, there is a possibility that audio information of two or more advertisements is simultaneously output. In this case, the user is not able to recognize the audio of each advertisement, and feels the sense of discomfort. As a result, the advertising effectiveness might be decreased.

In the latter prior art, because of the absence of descriptions regarding relevance between the web page and the advertisements, the output advertising audio is not necessarily relevant to the web page accessed by the user. Such advertising audio output irrelevant to the web page turns out unsatisfactory in terms of the advertising effectiveness. Furthermore, because of the absence of descriptions for controlling audio output for the plurality of advertisements, there is a possibility that audio information of two or more advertisements is simultaneously output. In this case, the use is not able to recognize the audio of each advertisement, and feels the sense of discomfort. As a result, the advertising effectiveness might be decreased.

In view of the stated problems, an objective of the present invention is to provide an advertising audio control device, an integrated circuit, an advertising audio control method, an advertising audio control program, and a recording medium, all of which realize output of advertising audio that is highly likely to attract the interest of the user, while preventing the other advertising audio from interfering with the output advertising audio.

### Solution to Problem

In order to solve the above problems, one aspect of the present invention provides an advertising audio control device to which an output device and home appliances are connected, the output device having a display function and an audio output function, the advertising audio control device comprising: a storage unit storing service applications and advertising applications, each service application corresponding to one or more of the advertising applications and associated with a different one of the home appliances; and a control unit operable to (i) cause the output device to display the service applications stored in the storage unit on a display panel of the output device, (ii) select one service application from among the displayed service applications, (iii) detect an advertising application corresponding to the selected service application from among the advertising applications stored in the storage unit, and (iv) cause the output device to output audio of the detected advertising application.

### Advantageous Effects of Invention

With the above advertising audio control device, the advertising application corresponding to the selected service application is detected, and audio is output for the detected application. This makes it possible to output the audio of the advertising application that is highly likely to attract the interest of the user, while preventing the other audio outputting advertising applications from interfering with the audio output of the advertising application.

### BRIEF DESCRIPTION OF DRAWINGS

FIG. 1 shows a network configuration according to an embodiment.

FIG. 2 shows a functional configuration of a control unit of FIG. 1.

FIG. 3 shows an example of a portal screen displayed as a top-level screen on a display device of FIG. 1.

FIG. 4 shows an example of a detailed screen of a service application displayed on the display device of FIG. 1.

FIG. 5 shows an example of a life targeting table stored in a storage unit of FIG. 1.

FIG. 6 shows an example of a playback audio selection table stored in a storage unit of FIG. 1.

FIG. 7 is a flowchart showing procedures of advertising audio control processing (user selection) performed by the control unit of FIG. 2.

FIG. 8 is a flowchart showing procedures of service application display processing of FIG. 7.

FIG. 9 is a flowchart showing procedures of advertising audio output processing of FIG. 7.

FIG. 10 is a flowchart (continued from FIG. 9) showing the procedures of the advertising audio output processing of FIG. 7.

FIG. 11 is a flowchart showing upper-level/top-level screen transition processing of FIG. 7.

FIG. 12 shows an example of a portal screen displayed as the top-level screen on the display device of FIG. 1.

FIG. 13 shows an example of a detailed screen of a service application displayed on the display device of FIG. 1.

FIG. 14 shows another example of a screen displayed on the display device of FIG. 1.

FIG. 15 shows another example of a portal screen displayed on the display device of FIG. 1.

FIG. 16 shows another example of a screen displayed on the display device of FIG. 1.

FIG. 17 shows another example of a screen displayed on the display device of FIG. 1.

FIGS. 18A, 18B, and 18C show exemplary playback audio selection tables.

FIG. 19 shows another exemplary playback audio selection table.

FIG. 20 shows another example of a screen displayed on the display device of FIG. 1.

FIG. 21 shows another example of a screen displayed on the display device of FIG. 1.

FIG. 22 is a flowchart showing procedures of advertising audio control processing (termination of an operation of a home appliance) performed by the control unit of FIG. 2.

FIG. 23 shows another example of a screen displayed on the display device of FIG. 1.

FIG. 24 shows another example of a screen displayed on the display device of FIG. 1.

### DESCRIPTION OF EMBODIMENTS

One aspect of the present invention provides a first advertising audio control device to which an output device and home appliances are connected, the output device having a display function and an audio output function, the advertising audio control device comprising: a storage unit storing service applications and advertising applications, each service application corresponding to one or more of the advertising applications and associated with a different one of the home appliances; and a control unit operable to (i) cause the output device to display the service applications stored in the storage unit on a display panel of the output device, (ii) select one service application from among the displayed service applications, (iii) detect an advertising application corresponding to the selected service application from among the advertising applications stored in the storage unit, and (iv) cause the output device to output audio of the detected advertising application.

Another aspect of the present invention provides a first integrated circuit mounted on an apparatus to which an output device and home appliances are connected, the output device having a display function and an audio output function, the apparatus including a storage unit storing service applications and advertising applications, each service application corresponding to one or more of the advertising applications and associated with a different one of the home appliances, the integrated circuit comprising: a control unit operable to (i) cause the output device to display the service applications stored in the storage unit on a display panel of the output device, (ii) select one service application from among the displayed service applications, (iii) detect an advertising application corresponding to the selected service application from among the advertising applications stored in the storage unit, and (iv) cause the output device to output audio of the detected advertising application.

Yet another aspect of the present invention provides a first advertising audio control method used in an apparatus to which an output device and home appliances are connected, the output device having a display function and an audio output function, the apparatus including a storage unit storing service applications and advertising applications, each service application corresponding to one or more of the advertising applications and associated with a different one of the home appliances, the advertising audio control method comprising the steps of: causing the output device to display the service applications stored in the storage unit on a display panel of the output device; selecting one service application from among the displayed service applications; detecting an advertising application corresponding to the selected service application from among the advertising applications stored in the storage unit; and causing the output device to output audio of the detected advertising application.

Yet another aspect of the present invention provides a first advertising audio control program used in an apparatus to which an output device and home appliances are connected, the output device having a display function and an audio output function, the apparatus including a storage unit storing service applications and advertising applications, each service application corresponding to one or more of the advertising applications and associated with a different one of the home appliances, the advertising audio control program comprising the steps of: causing the output device to display the service applications stored in the storage unit on a display panel of the output device; selecting one service application from among the displayed service applications; detecting an advertising application corresponding to the selected service application from among the advertising applications stored in the storage unit; and causing the output device to output audio of the detected advertising application.

Yet another aspect of the present invention provides a first recording medium storing therein an advertising audio control program used in an apparatus to which an output device and home appliances are connected, the output device having a display function and an audio output function, the apparatus including a storage unit storing service applications and advertising applications, each service application corresponding to one or more of the advertising applications and associated with a different one of the home appliances, the advertising audio control program comprising the steps of: causing the output device to display the service applications stored in the storage unit on a display panel of the output device; selecting one service application from among the displayed service applications; detecting an advertising application corresponding to the selected service application from among the advertising applications stored in the storage unit; and causing the output device to output audio of the detected advertising application.

According to all of the advertising audio control device, the integrated circuit, the advertising audio control method, the advertising audio control program, and the recording medium mentioned above, the advertising application corresponding to the selected service application is detected, and audio is output for the detected application. This makes it possible to output the audio of the advertising application that is highly likely to attract the interest of the user, while preventing the other audio outputting advertising applications from interfering with the audio of the advertising application.

According to one aspect of the present invention directed to a second first advertising audio control device, the first advertising audio control device may be modified as follows. The service applications stored in the storage unit are displayed, on the display panel, in a top-level screen of a plurality of screens having a hierarchical display structure. Upon receiving, on the top-level screen, an instruction to display a lower-level screen with respect to one of the displayed service applications, the control unit selects the one of the displayed service applications as the one service application.

With the above structure, the audio is output for the advertising application corresponding to the one of the service applications. Since the user is likely to be interested in the one of the service applications, on which the instruction to display the lower-level screen has been made, the audio output for the corresponding advertising application increases the advertising effectiveness.

According to one aspect of the present invention directed to a third advertising audio control device, the second advertising audio control device may be modified as follows. The instruction is provided using a remote control unit for operating the output device.

With the above structure, the advertising effectiveness is increased for the following reason. That is to say, the user is likely to utilize services of the one of the service applications because the user has made the instruction to display the lower-level screen of the one of the service applications by using the remote control unit. The advertising corresponding to such a service application is highly expected to attract the interest of the user.

According to one aspect of the present invention directed to a fourth advertising audio control device, the second advertising audio control device may be modified as follows. The instruction is an operation completion notification of one of the home appliances. Upon receiving the operation completion notification, the control unit selects a service application associated with the one of the home appliances as the one service application.

With the above structure, the advertising effectiveness is increased, because the advertising corresponding to the service application associated with the home appliance used by the user is highly likely to attract the interest of the user.

According to one aspect of the present invention directed to a fifth advertising audio control device, the second advertising audio control device may be modified as follows. The top-level screen includes a first display area and a second display area. The control unit causes the output device to display, (i) in the first display area, the service applications stored in the storage unit, and (ii) in the second display area, advertising applications corresponding to at least one of the displayed service applications. Upon receiving the instruction to display the lower-level screen with respect to the one of the displayed service applications, the control unit further causes the output device to enlarge the lower-level screen in the first display area when the corresponding advertising application is displayed in the second display area.

With the above structure, when the advertising application corresponding to the one of the service applications is displayed in the second display area, the lower-level screen with respect to the one of the service applications is enlarged in the first display area. Accordingly, the screen on the display panel is effectively used for displaying the lower-level screen with respect to the one of the service applications, while the corresponding advertising application(s) are still displayed in the same screen.

According to one aspect of the present invention directed to a sixth advertising audio control device, the fifth advertising audio control device may be modified as follows. Upon receiving the instruction to display the lower-level screen with respect to the one of the displayed service applications, the control unit further causes the output device to enlarge the lower-level screen in a display area covering the first display area and the second display area when the corresponding advertising application is not displayed in the second display area.

With the above structure, when the advertising application corresponding to the one of the service applications is not displayed in the second display area, the lower-level screen with respect to the one of the service applications is enlarged in the display area covering the first display area and the second display area. Accordingly, the screen on the display panel is effectively used for displaying the lower-level screen with respect to the one of the service applications.

According to one aspect of the present invention directed to a seventh advertising audio control device, the first advertising audio control device may further comprise an audio storage unit storing one or more audio files for each advertising application, the one or more audio files being assigned with priority levels, wherein the control unit detects one audio file from among the audio files stored for the advertising application corresponding to the specified service application in the audio storage unit in accordance with the priority levels, and causes the output device to output audio for the detected audio file.

With the above structure, even when a plurality of audio files are present for one advertising application, only one of the audio files is selected according to the assigned priority orders so that the selected audio file is output. This prevents a situation where a plurality of audio files are output to interfere with each other.

According to one aspect of the present invention directed to an eighth advertising audio control device, the second advertising audio control device may be modified as follows. After the lower-level screen is displayed, the control unit causes the output device to stop the audio output upon receiving an instruction to return from the lower-level screen to the top-level screen.

This prevents the situation where the advertising audio in which the user is probably no longer interested is continuously output.

According to one aspect of the present invention directed to a ninth advertising audio control device, the second advertising audio control device may be modified as follows. After the lower-level screen is displayed, the control unit causes the output device to continue the audio output even upon receiving an instruction to return from the lower-level screen to a screen which is one level upper than the lower-level screen.

With the above structure, the audio output is continued for the advertising application in which the user is probably still interested. As a result, the advertising effectiveness is increased.

According to one aspect of the present invention directed to a tenth advertising audio control device, the second advertising audio control device may be modified as follows. After the lower-level screen is displayed, the control unit causes the output device to stop the audio output upon receiving an instruction to display any service application other than the specified service application.

This prevents the situation where the advertising audio in which the user is probably no longer interested is continuously output.

The following describes a preferred embodiment of the present invention with reference to the accompanying drawings.

### Embodiment

The following describes the embodiment of the present invention with reference to the accompanying drawings.

<Network Configuration>

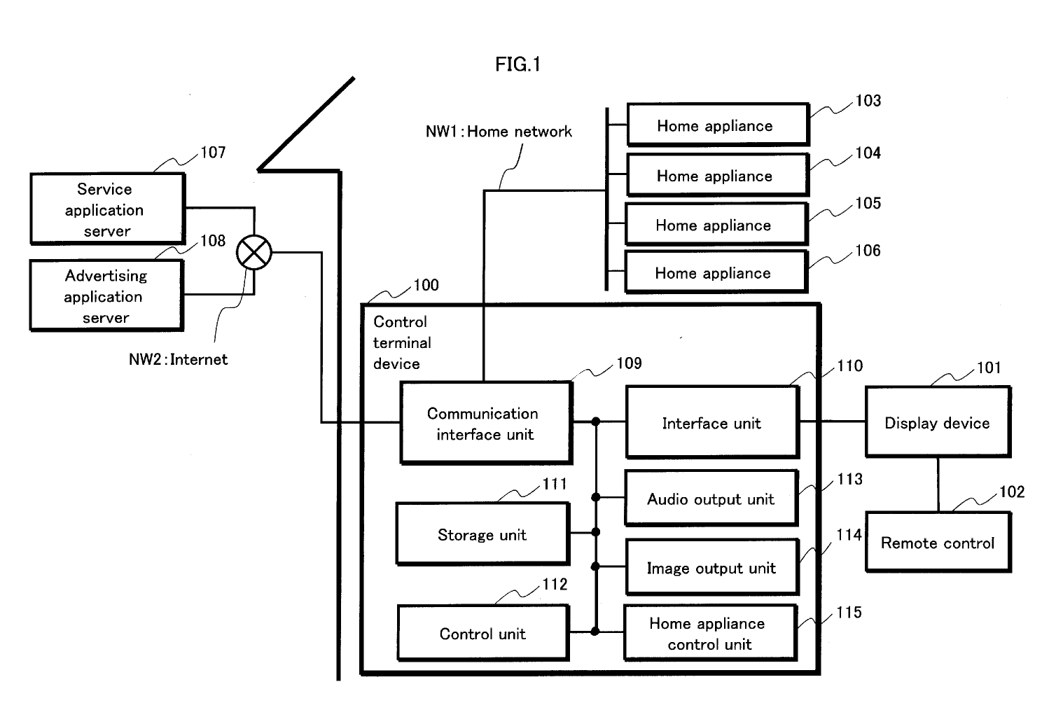

FIG. 1 shows a network configuration according to the embodiment. The network of FIG. 1 includes a control terminal device 100, a display device 101, a remote control 102, and home appliances 103 to 106. The network of FIG. 1 further includes a service application server 107 and an advertising application server 108.

The control terminal device 100 serves as an advertising audio control device and is, for example, a digital recorder.

The control terminal device 100 is connected with the service application server 107 and the advertising application server 108 via internet NW2. The service application server 107 distributes applications (referred to below as “service applications”) for achieving services using the home appliances at home. The control terminal device 100 receives the service applications from the service application server 107 via the internet NW2. The application server 108 distributes applications (referred to below as “advertising applications”) for providing advertisements. The control terminal device 100 receives the advertising applications from the application server 108 via the internet NW2.

The control terminal device 100 is connected with the display device 101. The display device 101 is one example of an output device having a display function and an audio output function. The connection between the control terminal device 100 and the display device 101 is made using, for example, a digital cable, such as an HDMI (High-Definition Multimedia Interface) cable. The control terminal device 100 outputs image data and audio data to the display device 101. The display device 101 displays an image on a display panel in accordance with the image data received from the control terminal device, and outputs audio from a speaker in accordance with the audio data received from the control terminal device 100. Via the display device 101, the remote control 102 outputs an operation instruction signal indicating an operation command received from a user on the display device 101 and the like to the control terminal device 100, for example.

The control terminal device 100 is connected with the home appliances 103 to 106 via a home network NW1. The home appliances 103 to 106 refer to the home appliances at home, such as a washing machine, a rice cooker, a weight scale, an air conditioner, a refrigerator, and a microwave. Note that, however, the home appliances 103 to 106 are not limited to the above appliances.

<Hardware Configuration of Control Terminal Device>

As shown in FIG. 1, the control terminal device 100 includes a communication interface unit 109, an interface unit 110, a storage unit 111, a control unit 112, an audio output unit 113, an image output unit 114, and a home appliance control unit 115.

The communication interface unit 109 is connected to the internet NW2. The communication interface unit 109 is provided for the control terminal device 100 to exchange data with the service application server 107 and the application server 108 which are also connected to the internet NW2. For example, the control unit 112 receives a service application from the service application server 107 via the communication interface unit 109 and stores the received service application in the storage unit 111. The control unit 112 also receives an advertising application from the advertising application server 108 via the communication interface unit 109 and stores the received advertising application in the storage unit 111.

The communication interface unit 109 is also connected to the home network NW1. The communication interface unit 109 is provided for the control terminal device 100 to exchange data with the home appliances 103 to 106 which are also connected to the home network NW1. For example, the home appliance control unit 115 transmits the operation instruction signal to the home appliances 103 to 106 via the communication interface unit 109. The home appliance control unit 115 also receives signals indicating operation histories or operation states from the home appliances 103 to 106 via the communication interface unit 109 and outputs the received signals to the control unit 112.

The interface unit 110 is provided for the control terminal device 100 to exchange data with the display device 101.

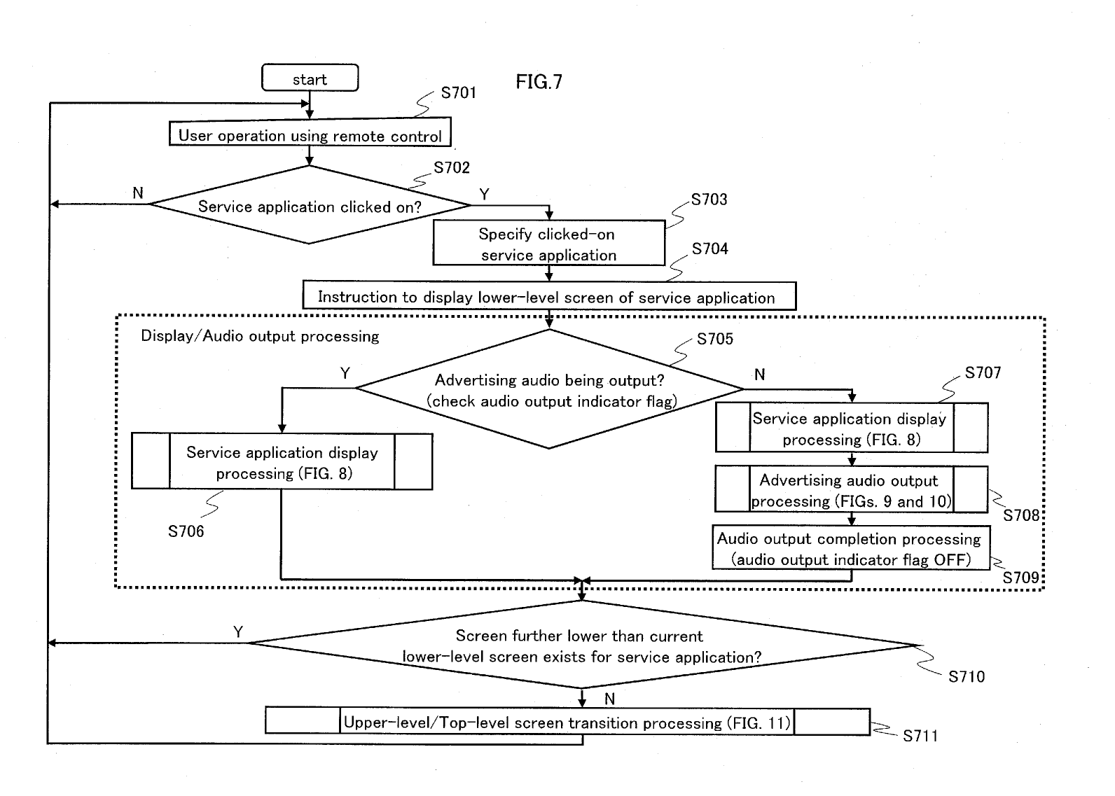

The storage unit 111 is a non-volatile storage device that is capable of maintaining the stored content even during, for example, the power-off. The storage unit 111 stores therein programs, such as various control programs and various application programs. The programs stored in the storage unit 111 include a program for the user to output audio of an advertising application corresponding to a service application of the home appliance which has been selected by the user or whose operation has been completed. Such a program describes operation procedures shown in FIGS. 7 to 11 and FIG. 22.

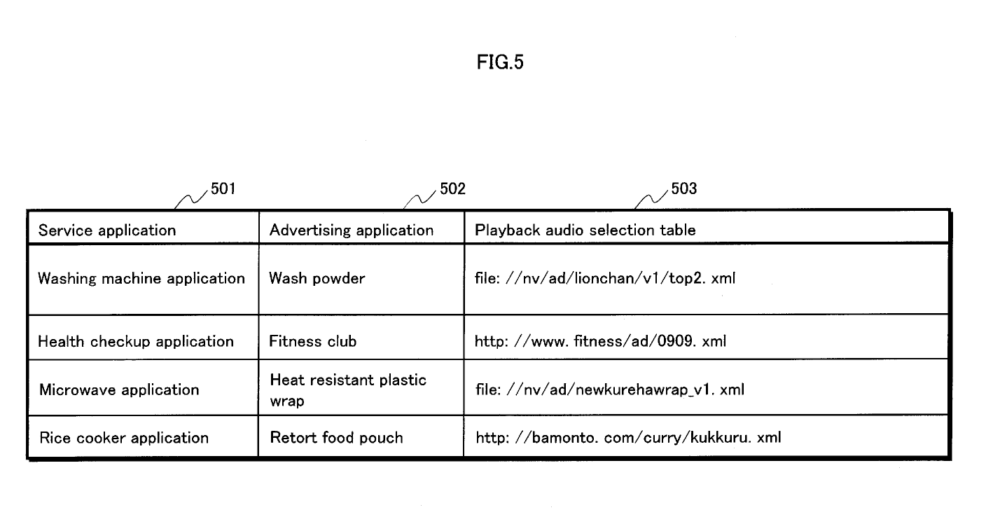

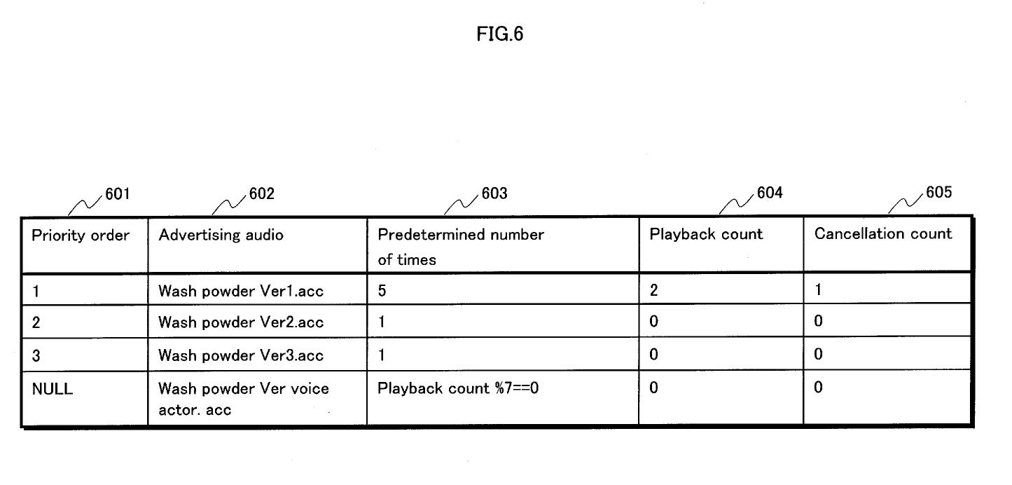

The storage unit 111 also stores therein the service applications and the advertising applications. Furthermore, the storage unit 111 stores therein a life targeting table 210 (see FIG. 5) and a playback audio selection table 211 (see FIG. 6) which are described later, in addition to an audio output indicator flag. In the embodiment, only one audio output indicator flag is stored, and the audio output indicator flag indicates “ON” when audio of an advertising application is being output and indicates “OFF” when audio of an advertising application is not being output. The audio output indicator flag does not need to be one bit long, and a plurality of audio output indicator flags may be stored for the respective advertising applications.

The control unit 112 is, for example, a CPU (Central Processing Unit). The control unit 112 reads the programs stored in the storage unit 111 to execute the read programs. By doing so, the control unit 112 performs various control for the entire control terminal device 100 and calculations. For example, the control unit 112 reads from the storage unit 111 the program describing the operation procedures shown in FIGS. 7 to 11, and FIG. 22, and executes the read program.

The audio output unit 113 is controlled by the control unit 112. For example, the audio output unit 113 outputs an audio signal indicating information relating to an advertising application selected by the control unit 112, to the display device 101 via the interface unit 110. The image output unit 114 is controlled by the control unit 112. For example, the image output unit 114 outputs a video signal or an image signal indicating information relating to a service application or an advertising application, to the display device 101 via the interface unit 110.

The home appliance control unit 115 is controlled by the control unit 112. The home appliance control unit 115 controls, via the communication interface unit 110, operations of the home appliances 103 to 106 connected to the home network NW1. The home appliance control unit 115 receives the signals indicating the operation histories or the operation states from the home appliances 103 to 106 and others via the communication interface unit 110.

<Functional Configuration of Control Unit>

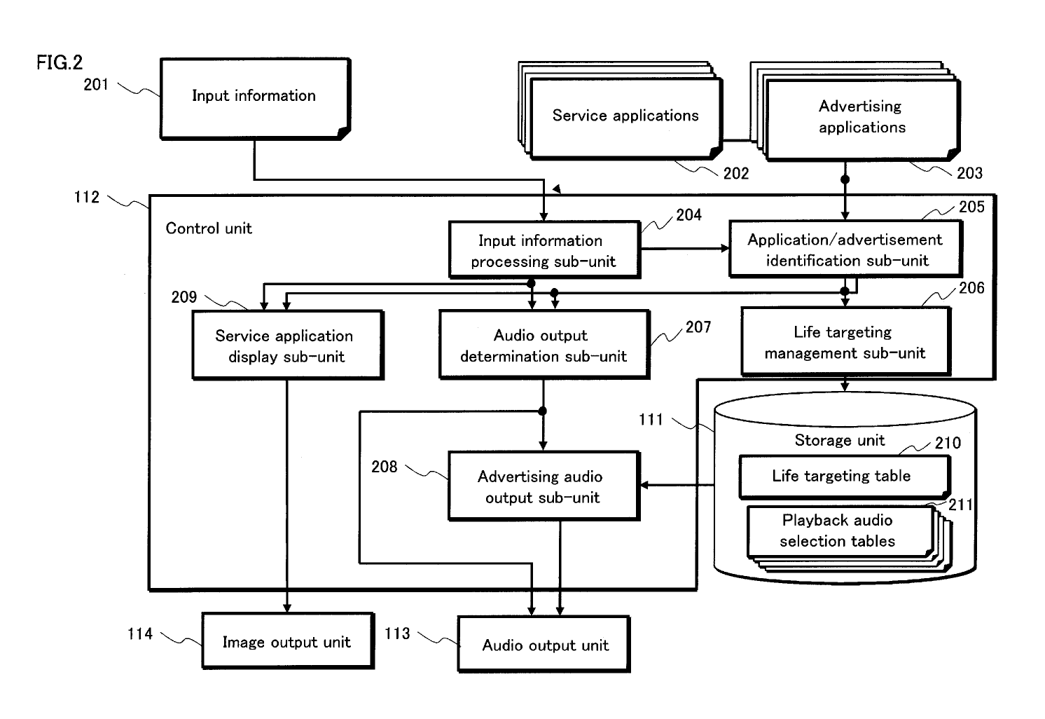

FIG. 2 shows a functional configuration of the control unit 112 included in the control terminal device 100 of FIG. 1. The control unit 112 reads from the storage unit 111 the program describing operation procedures shown in FIGS. 7 to 11, and executes the read program. By doing so, the control unit 112 serves as an input information processing sub-unit 204, an application/advertisement identification sub-unit 205, a life targeting management sub-unit 206, an audio output determination sub-unit 207, an advertising audio output sub-unit 208, and a service application display sub-unit 209.

Prior to description of processing performed by various functional components of the control unit 112, a description is given below of information which is input to the control unit 112.

Various data, such as input information 201, service applications 202, and advertising applications 203, is input to the control unit 112.

The input information 201 refers to the information received from the user on the display device 101 via the remote control 102, or the information received from the home appliance control unit 115.

The service applications refer to applications by which the user is able to enjoy services using one or more of the home appliances. In other words, each service application is provided for the user to utilize a variety of services using one or more home appliances. As mentioned above, the service applications 202 are distributed from the service application server 107 to the control terminal device 100, and then stored in the storage unit 111.

Note that in the embodiment the service applications 202 do not have the audio output function. The audio output function is provided not in the service applications whose contents are not updated during use, but in the advertising applications whose contents are updated as needed. This establishes an effective system in which the advertising applications have the audio output function necessary for appealing to the user, while the service applications are simplified. Needless to say, the contents of the service applications 202 may be appropriately changed, and the service applications 202 may have the audio output function.

The following describes possible service applications available as the service applications 202: (1) a service application for operating the washing machine by remote control, and a service application for instructing the user how to use the washing machine with the environment taken into consideration (referred to below as “washing machine applications”); (2) a service application for operating the rice cooker by remote control, and a service application for providing the user with recipes using the rice cooker (referred to below as “rice cooker applications”); (3) a service application for conducting a simple health checkup based on information received from the weight scale and a blood-pressure meter, and a service application for informing the user of temporal changes in the weight and the blood-pressure for the purpose of health checkup (referred to below as “health checkup applications”); and (4) a service application for providing the user with diet recipes and beauty recipes using the microwave (referred to below as a “microwave application”).

The service applications 202 are each provided with, for example, keywords as attribute information pieces associated with the service applications 202. For example, the keywords of the washing machine application are “wash powder”, “washing”, and “household”.

The advertising applications refer to applications for providing advertising to the user by audio. Note that the advertising applications include (1) an advertising application for providing advertising to the user only by audio and (2) an advertising application for providing advertising to the user by a video or an image, in addition to audio. As mentioned above, the advertising applications 203 are distributed from the advertising application server 108 to the control terminal device 100, and then stored in the storage unit 111.

The following describes possible advertising applications available as the advertising applications 203: (1) an advertising application for a washing powder for use in the washing machine; (2) an advertising application for a fitness club bringing up health improvement; (3) an advertising application for a heat resistant plastic wrap usable in the microwave; and (4) an advertising application for a retort food pouch convenient as a dish accompanied with rice.

The advertising applications 203 each hold attribute information pieces associated with the advertisements. For example, the attribute information pieces are the keywords, advertising fee, predetermined number of times for which audio (referred to below as “advertising sound” or “advertising audio” as needed) of the associated advertising application is to be output, or a name assigned to the audio file of the associated advertising application. In a case where a plurality of audio files are present for one advertising application, these audio files are assigned with priority orders. The attribute information pieces are provided on the application server 108.

A description is given below of the outline of the processing performed by the various functional components of the control unit 112. As for the details of the processing performed by the various functional components of the control unit 112, a description is given later below with reference to flowcharts of FIG. 7 etc.

The input information processing sub-unit 204 analyzes the input information 201 and performs processing in accordance with the analyzed input information 201. In a case where the input information 201 is the operation instruction from the user using the remote control 102, the input information processing sub-unit 204 outputs a signal to the application/advertisement identification sub-unit 205 for instructing the application/advertisement identification sub-unit 205 to determine whether the user operation using the remote control 102 has been made on a service application or not. In a case where the input information 201 is the information from the home appliance control unit 115, the input information processing sub-unit 204 outputs a signal in accordance with the input information to the audio output determination sub-unit 207 and the service application display sub-unit 209.

The application/advertisement identification sub-unit 205 identifies whether the application that has been input is a service application or an advertising application, and the identified information is managed in the life targeting table management unit 206. The identification may be made with use of contents of the attribute information pieces or an extension of the audio file, and not particularly limited to these methods as long as it is identified whether the application is a service application or an advertising application. In response to the determination instruction signal from the input information processing sub-unit 204 as mentioned above, the application/advertisement identification sub-unit 205 also identifies whether or not the user operation using the remote control 102 has been made on a service application. When it is identified that the user operation using the remote control 102 has been performed on a service application, the application/advertisement identification sub-unit 205 further identifies one service application from among the plurality of service applications on which the user operation using the remote control 102 has been made.

The life targeting management sub-unit 206 sequentially associates the service application 202 identified by the application/advertisement identification sub-unit 205 with the corresponding advertising application 203 one-by-one with use of the attribute information pieces to create one life targeting table 210 (see FIG. 5). The life targeting management sub-unit 206 also creates one or more playback audio selection tables 211 (see FIG. 6) in accordance with the attribute information pieces provided for the service application 202 and the advertising application 203. The life targeting table 210 and the playback audio selection tables 211 created by the life targeting management sub-unit 206 are stored in the storage unit 111.

The association made by the life targeting management sub-unit 206 between the service application 202 and the advertising application 203 is performed with use of the keywords which are attribute information pieces of the advertising application 203 and the advertising application 203. For example, when the “washing machine application” is provided with the keyword “washing”, and the advertising application for the “wash powder” is similarly provided with the keyword “washing”, the “washing machine application” is associated with the advertising application for the “wash powder” by the keyword “washing”. Note that in a case where a plurality of advertising applications are present as candidates for the association with one service application, these advertising applications are compared with each other with use of the advertising fees, which are also provided as the attribute information pieces of the respective advertising applications. Then, one advertising application with the highest advertising fee is uniquely associated with the service application. The method for uniquely associating the service application with one advertising application is not limited to the above method using the advertising fees, and may be another method using degrees of coincidence between the keyword of the service application and the keywords of the advertising applications.

The audio output determination sub-unit 207 checks, when the user has focused on and clicked on a service application by operating the remote control, for example, whether or not audio of the advertising application corresponding to the clicked-on service application is being output, with use of the value indicated by the audio output indicator flag. Then, in accordance with a result of the checking, the audio output determination sub-unit 207 determines whether or not to output the audio of the advertising application corresponding to the clicked-on service application. Note that the audio output determination sub-unit 207 determines that the audio of the advertising application corresponding to the service application should be output when the audio output indicator flag indicates “OFF”.

When the audio output determination sub-unit 207 determines that the audio of the corresponding advertising application should be output, for example, the advertising audio output sub-unit 208 refers to the life targeting table 210 and the playback audio selection table 211 to select the audio file of the advertising application to be output, and sends a signal to the audio output unit 113 for instructing the audio output unit 113 to output the selected audio file.

The service application display sub-unit 209 outputs a signal to the image output unit 114 for instructing the image output unit 114 to display a lower-level screen showing the details of the service application, a screen one level upper than the lower-level screen, or a top-level screen, in accordance with the input from the input information processing sub-unit 204 and the application/advertisement identification sub-unit 205.

<Examples of Screen Displayed on Display Device>

[Example of Top-Level Screen]

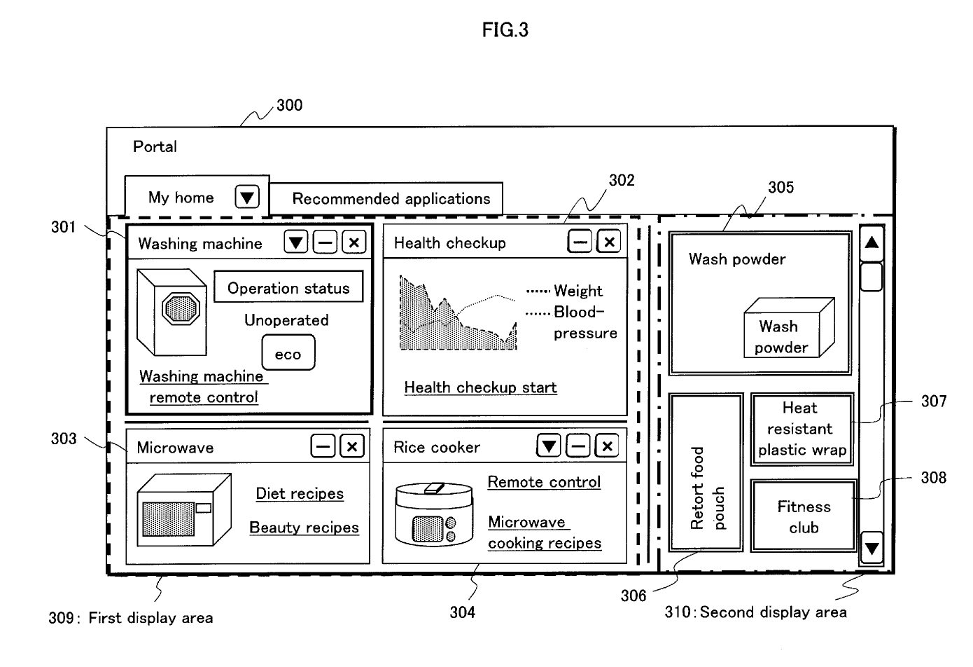

FIG. 3 shows an example of a portal screen displayed as the top-level screen on the display device 101 of FIG. 1.

The top-level screen includes one or more service applications and one or more advertising applications. The top-level screen includes a first display area 309 in which the one or more service applications are displayed and a second display area 310 in which the one or more advertising applications are displayed. The first display area 309 contains tabs that allow switching of the one or more service applications displayed in the first display area 309. In the example of FIG. 3, the top-level screen contains a “my home” tab and a “recommended applications” tab, so that the one or more of the service applications displayed in the first picture area can be switched. The second display area 310 contains a scroll bar that allows the control terminal device 100 to switch display of the plurality of advertising applications 16 that have been acquired from the application server 108 and stored in the storage unit 111.

In the example of the top-level screen of FIG. 3, a washing machine application 301, a health checkup application 302, a microwave application 303, and a rice cooker application 304 are displayed in the first display area 309 as the service applications. On the other hand, an advertising application 305 for the “wash powder”, an advertising application 306 for the “retort food pouch”, an advertising application 307 for the “heat resistant plastic wrap”, and an advertising application 308 for the “fitness club” are displayed in the second display area 310 as the advertising applications.

[Example of Detailed Screen of Service Application]

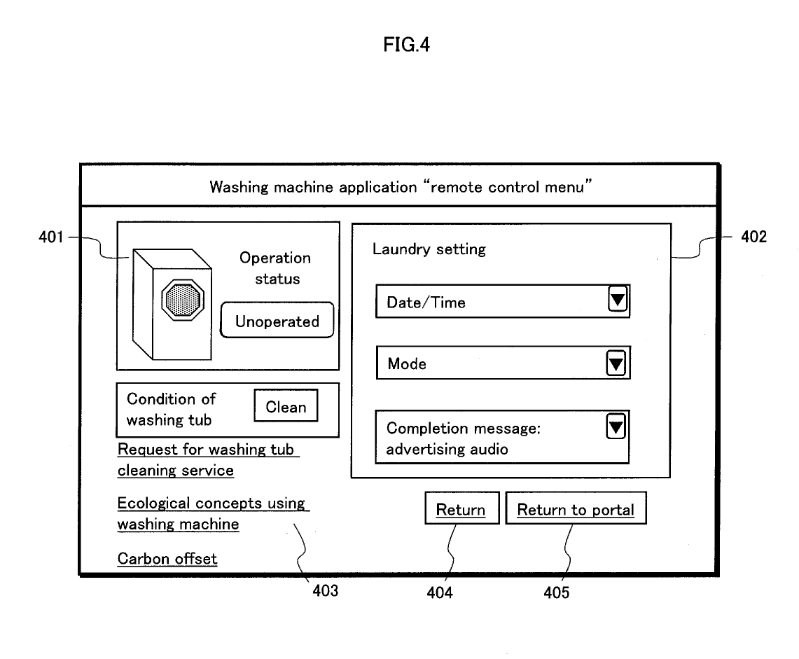

FIG. 4 shows an example of the detailed screen of a service application displayed on the display device 101 of FIG. 1. The example shown in FIG. 4 is the detailed screen of the washing machine application 301 displayed on the display device 101 when the user has focused on and clicked on the washing machine application 301 of FIG. 3 by operating the remote control. The service application has a hierarchical display structure, whereby, when the user selects one of the displayed service applications itself or a link contained in the one of the displayed service applications by operating the remote control 102, the detailed information of the selected service application is displayed as the lower-level screen of the selected service application.

For example, as the detailed screen of the washing machine application 301, a remote operation menu screen is displayed. In the example of FIG. 4, the detailed screen of the washing machine application 301 contains a menu item 401 displaying an operation status of the washing machine, a menu item 402 on which the user is able to program the washing machine to start at a specified time, a “return” button 404 that enables the user to return to a screen one level upper than the current screen, and a “return to portal” button 405 that enables the user to return to the top-level (portal) screen. The detailed screen of the washing machine application 301 also contains a link 403 for transitioning further from the remote operation menu screen to another detailed screen showing ecological concepts using the washing machine as the detailed service information.

The display size of the detailed screen of the washing machine application 301 can differ from the display size of the washing machine application 301 shown in FIG. 3. For example, during the display of FIG. 3, the service application display sub-unit 209 displays the lower-level screen (detailed screen) while enlarging the display size of the lower-level screen compared with the washing machine application 301 of FIG. 3, when the user focuses on and clicks on the washing machine application 301 by operating the remote control 102, providing that the washing machine application 301 is set to be enlarged. It is also possible to display the lower-level screen without changing the display size, by not setting the service application to be enlarged.

<Example of Life Targeting Table>

FIG. 5 shows an example of the life targeting table 210 stored in the storage unit 111 of FIG. 1. Note that the exemplary life targeting table 210 shown in FIG. 5 has been created by the life targeting management sub-unit 206 by associating the service applications with the corresponding advertising applications.

The life targeting table 210 is composed of a service application column 501, an advertising application column 502 corresponding to the service application column 501, and a playback audio selection table column 503 describing one or more audio files for each advertising application. In the service application column 501, names of the service applications are described. In the advertising application column 502, names of the advertising applications corresponding to the service applications are described. In the playback audio selection table column 503, path information pieces are described. Each of the path information pieces indicates whereabouts of the playback audio selection tables each indicating one or more audio files for the corresponding advertising application.

In the example of FIG. 5, in the service application column 501, the “washing machine application”, the “health checkup application”, the “microwave application”, and the “rice cooker application” are described. In the advertising application column 502, the “wash powder”, the “fitness club”, the “heat resistant plastic wrap”, and the “retort food pouch” are described in correspondence with the “washing machine application”, the health checkup application”, the “microwave application”, and the rice cooker application”, respectively. In the playback audio selection table column 503, “file: //nv/ad/lionchan/v1/top2.xml”, “http: //www. fitness/ad/0909.xml”, “file: //nv/ad/newkurehawrap_v1.xml”, and “http: //bamonto. com/curry/kukkuru.xml” are described in correspondence with the “wash powder”, the “fitness club”, the “heat resistant plastic wrap”, and the “retort food pouch”, respectively.

The path information pieces described in the playback audio selection table column 503 may be paths indicating files stored in the control terminal device 100, or paths indicating files archived on the application server 108 which is an outside server, for example.

<Example of Playback Audio Selection Table>

FIG. 6 shows an example of the playback audio selection tables 211 stored in the storage unit 111 of FIG. 1. Note that the exemplary playback audio selection table 211 shown in FIG. 6 has been already created by the life targeting management sub-unit 206 in accordance with the attribute information pieces of the corresponding advertising application.

In the playback audio selection table 211, one or more audio information pieces and attribute information pieces of the corresponding advertising application are described. The playback audio selection table 210 is composed of a priority order column 601, an advertising audio column 602, a predetermined number of times column 603, a playback count column 604, and a cancellation count column 605.

In the priority order column 601, the priority orders of the audio files corresponding to the advertising application to be output are described in figures. In the embodiment, it is assumed that the smaller the figure is, the higher the priority order is. Of course, there is no problem to set so that the greater the figure is, the higher the priority order is. In accordance with the priority order column 601, the advertising audio output sub-unit 208 selects one of the audio files of the advertising application to be output. Apart from the figures, “NULL” may also be described in the priority order column 601. In a case where “NULL” is described in the priority order column 601, conditions necessary for playback of the audio files are described in the predetermined number of times column 603.

In the advertising audio column 602, the names assigned to the audio files of the advertising audio to be output are described. The names of the audio files described in the advertising audio column 602 may be the path information pieces of the audio files stored in the control terminal device 100, or the path information pieces of the audio files archived on the application server 108.

In the predetermined number of times column 603, the numbers of times for which the audio files of the advertising audio are to be output are described. These numbers of times are determined in advance by the application server. Note that, however, in the case where “NULL” is described in the priority order column 601, the condition necessary for playback of the audio files are described in the predetermined number of times column 603, as mentioned above.

In the playback count column 604, described are the numbers of times for which the audio files of the advertising application have been played back. In the cancellation count column 605, described are the numbers of times for which the audio files of the advertising application have been stopped in the middle of the playback. The priority order column 601 is modified with use of the cancellation count column 605.

For example, it is now assumed that “file: //nv/ad/lionchan/v1/top2.Xml”, which is one of the path information pieces listed in the playback audio selection table column 503 of the life targeting table 210 shown in FIG. 5, links to the playback audio selection table shown in FIG. 6. In the playback audio selection table of FIG. 6, the figure “1” in the priority order column 601 corresponds to the audio file “wash powder Ver1.acc” in the advertising audio column 602, the predetermined number “5” in the predetermined number of times column 603, the playback count “2” in the playback count column 604, and the cancellation count “1” in the cancellation count column 605. As for the figures “2” and “3” in the priority order column 601, the details are shown in FIG. 6.

In a row in the advertising audio column 602 corresponding to “NULL” in the priority order column 601, the audio file “wash powder Ver voice actor.acc” is described. In the corresponding row in the predetermined number of times column 603, “playback count %7==0” is described as the condition for playback. This condition for playback refers to a condition under which the audio file “wash powder Ver voice actor.acc” described in the row in the advertising audio column 602 corresponding to “NULL” in the priority order column 601 is played back regardless of the contents of the priority order column 601, when the total count in the playback count column 604 is dividable by 7.

<Processing Operations of Control Unit>

[Advertising Audio Control Processing (User Selection)]

FIG. 7 is a flowchart showing procedures of the advertising audio control processing (user selection) performed by the control unit 112 of FIG. 2. Note that the life targeting table 210 and the playback audio selection table 211 have been already created by the life targeting management sub-unit 206.

The input information processing sub-unit 204 waits for the user operation using the remote control 102, and receives the input information 201 regarding the user operation using the remote control 102 (step S701). The input information processing sub-unit 204 then outputs the signal to the application/advertisement identification sub-unit 205 for instructing the application/advertisement identification sub-unit 205 to determine whether or not the user operation using the remote control 102 has been made on a service application. Then, the application/advertisement identification sub-unit 205 determines whether the user has focused on and clicked on the service application by operating the remote control (step S702).

The application/advertisement identification sub-unit 205 does not determine that the user has selected the service application unless the service application has been clicked on, even when it is focused on by the user operation using the remote control 102. The reason is that, if the advertising application corresponding to the service application is played back just because the service application is focused on by the remote control, the audio of the advertising application is unintentionally played back when the user is just moving the cursor focus on the service application by operating the remote control 102. This might hamper convenience of the user.

When the service application has not been clicked on (S702: N), the processing returns to the step S701. In this case, the input information processing sub-unit 204 monitors input of the input information 201 regarding the user operation using the remote control 102.

On the other hand, when the service application has been clicked on (S702: Y), the application/advertisement identification sub-unit 205 determines which service application has been clicked on to specify the clicked-on service application (step S703). Subsequently, the application/advertisement identification sub-unit 205 outputs a signal to the service application display sub-unit 209 for instructing the service application display sub-unit 209 to display a lower-level screen of the service application operated by the user. The application/advertisement identification sub-unit 205 also outputs a signal to the audio output determination sub-unit 207 for instructing the audio output determination sub-unit 207 to check whether audio of an advertising application is currently being output (step S704).

The audio output determination sub-unit 207 determines whether the audio (i.e. advertising audio) of any advertising application is already being output, when the service application has been focused on and clicked on by the user operation using the remote control 102 (step S705). The audio output determination sub-unit 207 checks whether or not the audio output indicator flag stored in the storage unit 111 indicates “ON”. When the audio output indicator flag indicates “ON”, the audio output determination sub-unit 207 determines that the advertising audio is being output. When the audio output indicator flag indicates “OFF”, the audio output determination sub-unit 207 determines that the advertising audio is not being output.

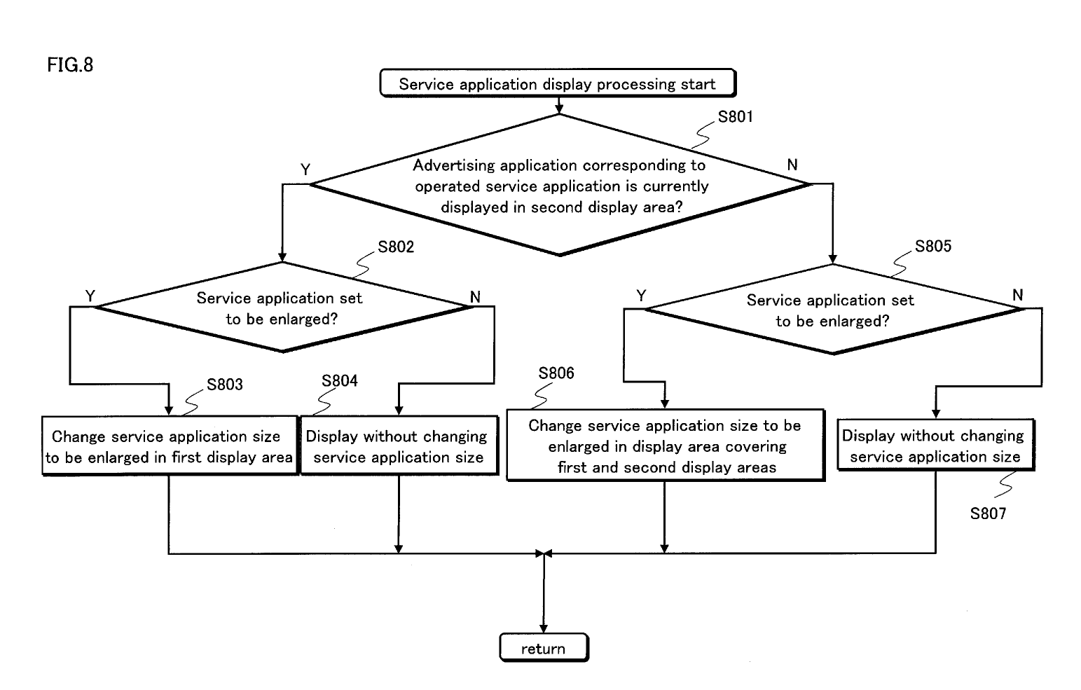

When the advertising audio is being output (S705: Y), this means that the audio of the advertising application is already being output. Accordingly, audio of the advertising application is not additionally output. In this case, the service application display sub-unit 209 performs service application display processing whose operation procedures are shown in FIG. 8 (step S706). The control unit 112 does not additionally output audio of the advertising application for the following reason. That is to say, if audio of the identical or a different advertising application is additionally output in a state where the audio of the advertising application is already being output, the audio of the advertising application is interrupted. This prevents accurate transmission of the content of the advertisement to the user.

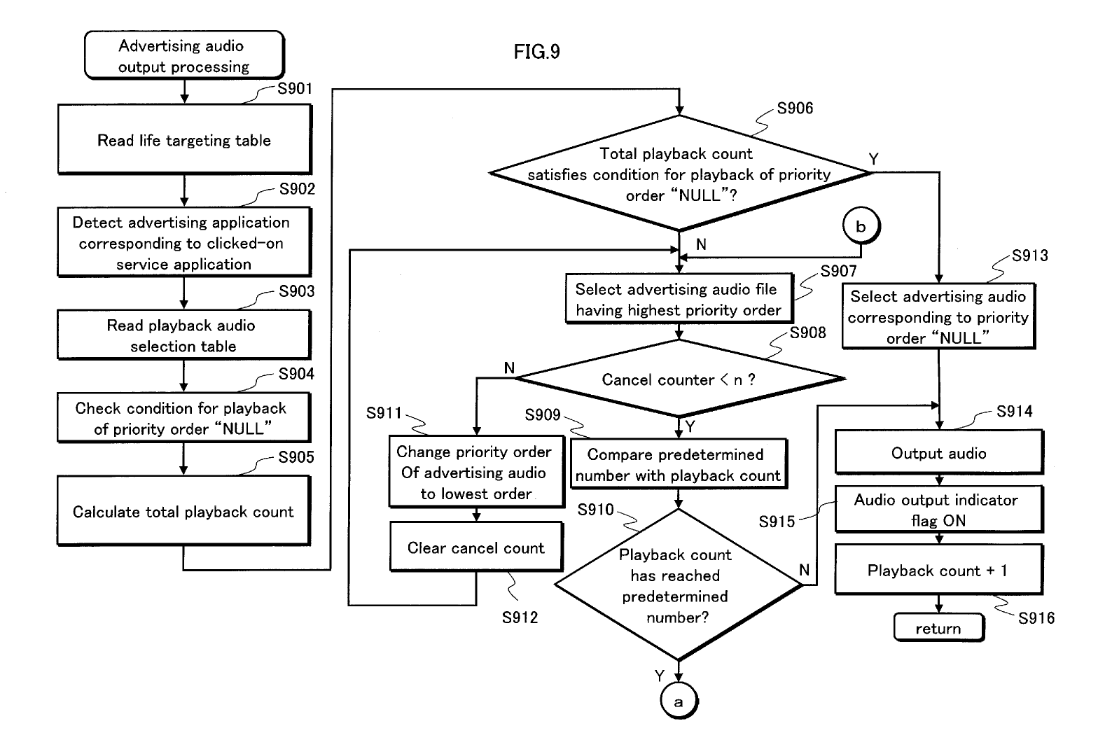

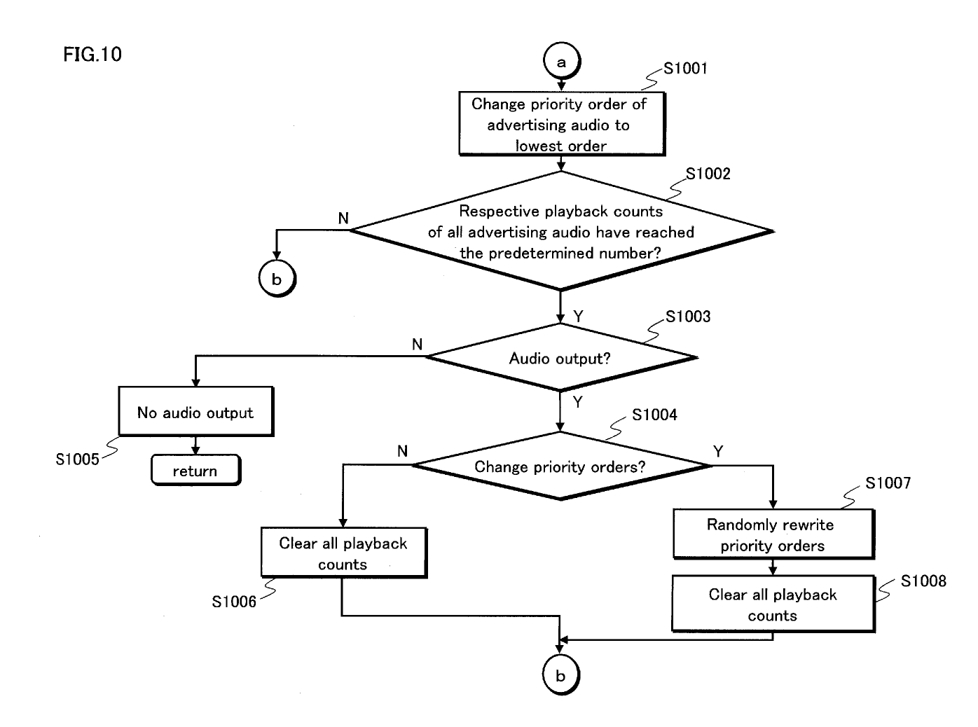

On the other hand, when the advertising audio is not being output (S705: N), the service application display sub-unit 209 performs the service application display processing whose operation procedures are shown in FIG. 8 (step S707). At the same time, the audio output determination sub-unit 207 outputs a signal to the advertising audio output sub-unit 208 for instructing the advertising audio output sub-unit 208 to output the advertising audio. The advertising audio output sub-unit 208 then performs advertising audio output processing whose operation procedures are shown in FIGS. 9 and 10 (step S708). Upon completing the audio output for the advertising application, the advertising audio output sub-unit 208 switches the audio output indicator flag from “ON” to “OFF” (step S709). Note that the (1) the service application display processing (step S707) and (2) the advertising audio output processing (step S708) and the audio output completion processing (step S709) are performed in parallel, for example.

Note that the service application display processing (step S707) is later described in the details with reference to FIG. 8, and the advertising audio output processing (step S708) is later described in the details with reference to FIGS. 9 and 10.

The service application display sub-unit 209 determines whether or not a screen further lower than the lower-level screen currently displayed exists for the service application, that is to say, whether or not the current lower-level screen is the lowest-level screen of the service application (step S710). When the screen further lower than the current lower-level screen exists for the service application (S710: Y), the processing returns to the step S701. In this case, the input information processing sub-unit 204 monitors input of the input information 201 regarding the user operation using the remote control 102. At this time, in response to a further instruction to display yet another lower-level screen, audio of the advertising application is newly selected. The reason is that the further instruction to display the yet another lower-level screen suggests that the user is highly interested in the identical home appliance or the service. This allows continuous audio output for the advertising application corresponding to the identical home appliance or service in which the user is interested, thereby greatly increasing the advertising effectiveness.

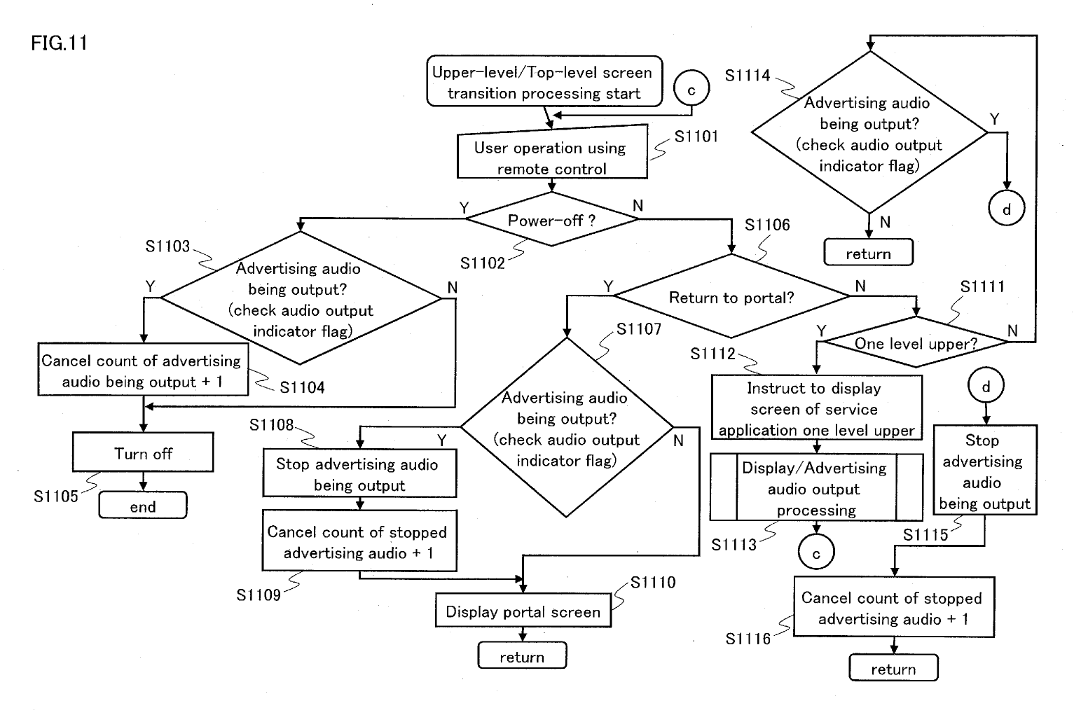

On the other hand, when the screen further lower than the current lower-level screen does not exist for the service application (S710: N), the control unit 112 performs upper-level/top-level screen transition processing for transitioning, for example, to a screen one level upper than the current lower-level screen or the top-level screen of the service application (step S711). The operation procedures of the upper-level/top-level screen transition processing (step S711) are shown in FIG. 11, and is later described in the details with reference to FIG. 11.

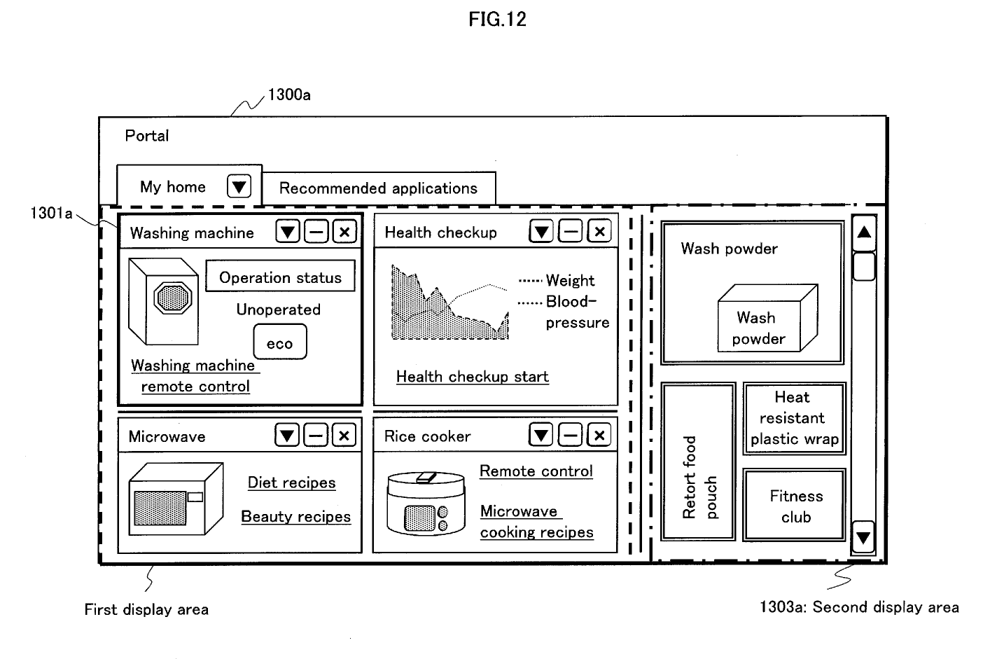

The following describes an example of the transitions of screen display in response to the advertising audio control processing (user selection) shown in FIG. 7, with reference to FIGS. 12 to 14.

The description is given of a case where the user has focused on and clicked on a washing machine application 1301a on a portal screen 1300a which is the top-level screen as shown in FIG. 12, for example. In this case, a detailed screen 1304b of the washing machine application as shown in FIG. 3, which is a lower-level screen of the washing machine application 1301a of FIG. 12, is displayed. The details of a method for displaying the lower-level screen of the service application are described later below with reference to FIG. 8. The advertising audio output sub-unit 208 selects the audio of the advertising application “wash powder” corresponding to the washing machine application simultaneously with the display of the lower-level screen of the service application. The selected audio of the advertising application is output. The details of a method for the advertising audio output sub-unit 208 to select the audio of the advertising application are described later below with reference to FIGS. 9 and 10.

It should be noted that there may be a case where the audio of the advertising application corresponding to the washing machine application is already being output when the washing machine application 1301a is focused on and clicked on by the user. In such a case, the detailed screen 1304b of the washing machine application is displayed without stopping the audio of the advertising application being output. On the other hand, in the case where the audio of the advertising application corresponding to the washing machine application is not yet being output, the detailed screen 1304b of the washing machine application is displayed, while the advertising audio output sub-unit 208 selects the audio of the advertising application “wash powder” and outputs the selected audio of the advertising application “wash powder”.

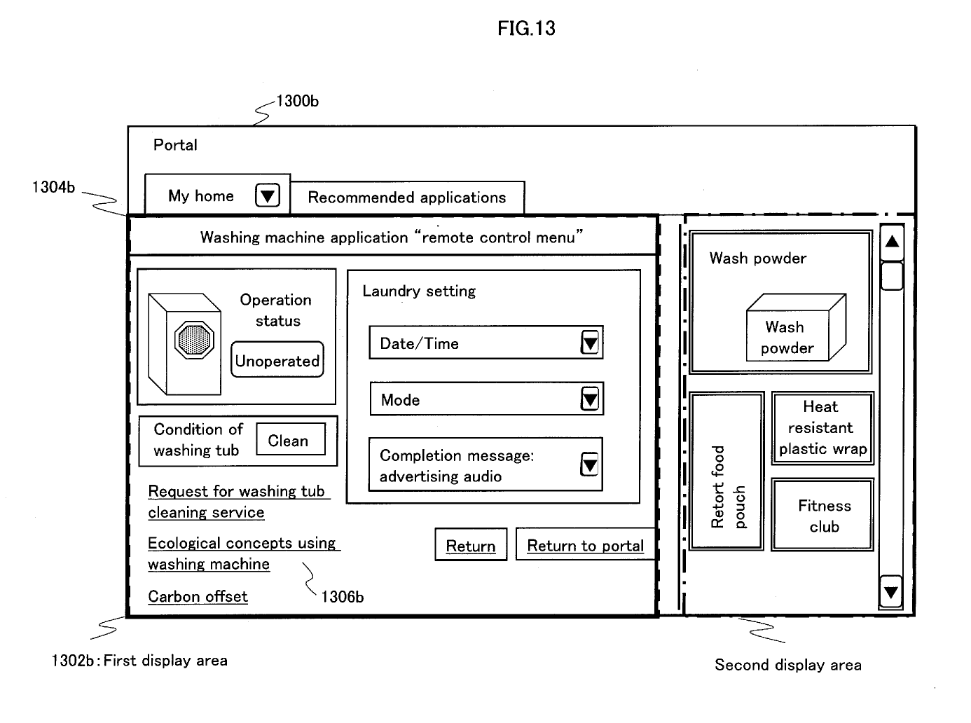

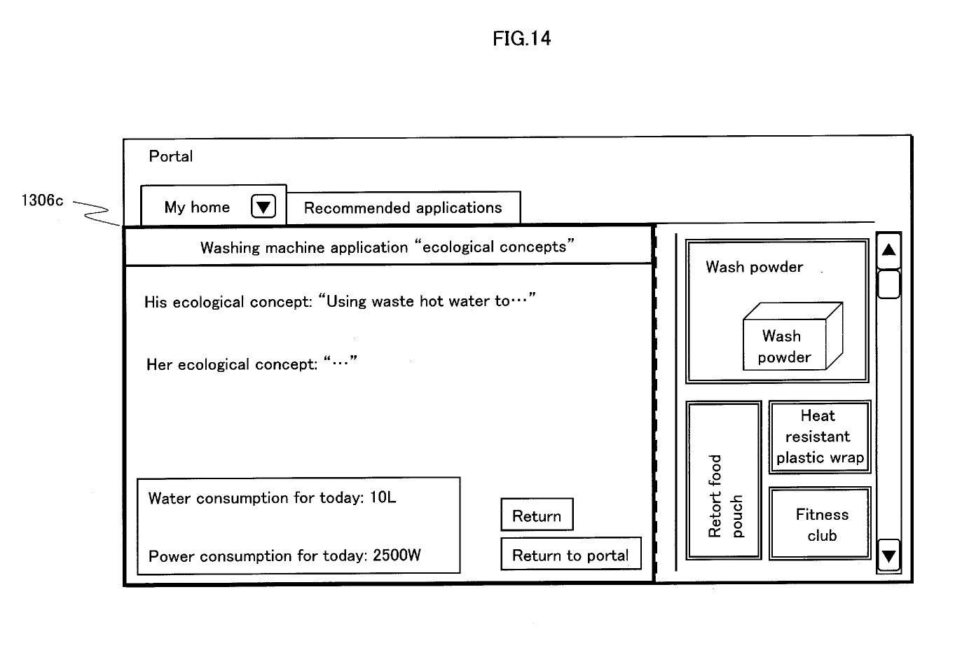

Furthermore, a description is given of a case where yet another detailed screen, in other words a lower-level screen even lower than the detailed screen 1304b of FIG. 13 exists for the washing machine application. For example, it is assumed that the detailed screen 1304b of FIG. 13 contains a link 1306b to “eco-related ideas using the washing machine”. When the user focuses on and clicks on the link 1306b to the “ecological concepts using the washing machine”, displayed is another detailed screen 1306c of the washing machine application of FIG. 14 which is one level lower than the detailed screen 1304b shown in FIG. 13.

It should be note that there may be a case where the audio of the advertising application is already being output when the link 1306b for the “ecological concepts using the washing machine” contained in the detailed screen 1304b of FIG. 13 is focused on and clicked on by the user by operating the remote control. In such a case, the detailed screen 1306c of FIG. 14 which is one level lower than the detailed screen 1304b of FIG. 13 is displayed without stopping the audio of the advertising application being output. On the other hand, in the case where the audio of the advertising application is not yet being output, the detailed screen 1306c of FIG. 14 is displayed, while the advertising audio output sub-unit 208 selects the audio of the advertising application “wash powder” and outputs the selected audio of the advertising application “wash powder”.

[Display Processing of Service Application]

FIG. 8 is a flowchart showing the procedures of the service application display processing of FIG. 7 (steps S706 and S707).

The service application display sub-unit 209 determines whether or not the advertising application corresponding to the service application focused on and clicked on by the user by operating the remote control (i.e. the service application operated by the user) is currently displayed in the second display area (see FIG. 3) (step S801). The determination about whether or not the advertising application corresponding to the service application is currently displayed is made by the service application display sub-unit 209 by referring to the life targeting table 210 stored in the storage unit 111.

When the advertising application corresponding to the service application operated by the user is currently displayed in the second display area (S801: Y), the service application display sub-unit 209 determines whether or not the service application operated by the user is set to be enlarged (step S802). The enlargement settings for the service application are configured differently from one service application to another, and these configurations are stored in the storage unit 111 as settings for the respective service applications.

When the service application operated by the user is set to be enlarged (S802: Y), the service application display sub-unit 209 changes the display size when displaying the lower-level screen of the service application operated by the user, so that the lower-level screen of the service application is enlarged in the first display area (see FIG. 3) (step S803). According to the above steps, when it is instructed to display the lower-level screen of the service application associated with one of the home appliances, the service application display sub-unit 209 determines whether or not the advertising application corresponding to the service application is currently displayed in the second display area (see FIG. 3). When the corresponding advertising application is currently displayed, the service application display sub-unit 209 enlarges the lower-level screen instructed to be displayed in the entire first display area of the display device 101. Accordingly, when the corresponding advertising application is displayed in the second display area, the service application display sub-unit 209 enlarges the lower-level screen as much as possible, while still allowing the corresponding advertising application(s) to be displayed together with the lower-level screen of the service application. As a result, the screen on the display device 101 is effectively used for displaying the lower-level screen that the user has instructed to display, while the advertising application(s) are still displayed in the same screen.

On the other hand, when the service application operated by the user is not set to be enlarged (S802: N), the service application display sub-unit 209 displays the lower-level screen without changing the display size of the service application (step S804).

When the advertising application corresponding to the service application operated by the user is not currently displayed in the second display area (S801: N), the service application display sub-unit 209 determines whether or not the operated service application is set to be enlarged (step S805).

When the service application operated by the user is set to be enlarged (S805: Y), the service application display sub-unit 209 changes the display size when displaying the lower-level screen of the service application operated by the user, so that the lower-level screen of the service application is enlarged in a display area covering the first display area (see FIG. 3) and the second display area (see FIG. 3) (step S806). For example, when the advertising application corresponding to the service application operated by the user is not currently displayed in the second display area due to scroll operations by the user, displaying the advertising application is no longer be expected to appeal to the user effectively. Accordingly, a priority is given to operability of the user, and the service application operated by the user is enlarged in the display area covering the first and the second display areas. According to the above steps, when it is instructed to display the lower-level screen of the service application associated with one of the home appliances, the service application display sub-unit 209 determines whether or not the advertising application corresponding to the service application is currently displayed in the second display area. When the advertising application corresponding to the service application is not currently displayed, the service application display sub-unit 209 enlarges the lower-level screen instructed to be displayed in the entire display area covering the first and the second display areas of the display device 101. In this way, when the corresponding advertising application is not currently displayed in the second display area, the lower-level screen is displayed in the entire display area covering the fist and the second display areas, such that the lower-level screen is preferentially displayed over the advertising application. Accordingly, the entire display screen of the display device 101 is effectively used for the display of the lower-level screen that the user has instructed to display, when the corresponding advertising application is not currently displayed in the second display area and the user can perceive only the audio of the corresponding advertising application.

On the other hand, when the service application operated by the user is not set to be enlarged (S805: N), the service application display sub-unit 209 displays the lower-level screen without changing the display size of the service application (step S807).

The following describes an example of the transitions of screen display in response to the service application display processing shown in FIG. 8, with reference to FIGS. 12, 13, 15, 16, 3, and 17.

To begin with, with reference to FIGS. 12 and 13, a description is given of an example for enlargement of the lower-level screen of the service application in the first display area.

For example, the description is given of a case where the user has focused on and clicked on the washing machine application 1301a by operating the remote control on the portal screen 1300a shown in FIG. 12. Note that it is presumed here that the washing machine application 1301a is by default set to be enlarged when the lower-level screen is displayed. In FIG. 12, the advertising application “wash powder” corresponding to the washing machine application 1301a is displayed in the second display area 1303a. Accordingly, the service application display sub-unit 209 changes the display size so that the remote operation menu screen, which is the detailed screen of the washing machine application, is enlarged in the first display area. Thus, as shown in FIG. 13, the remote operation menu screen 1304b is enlarged in a first display area 1302b.

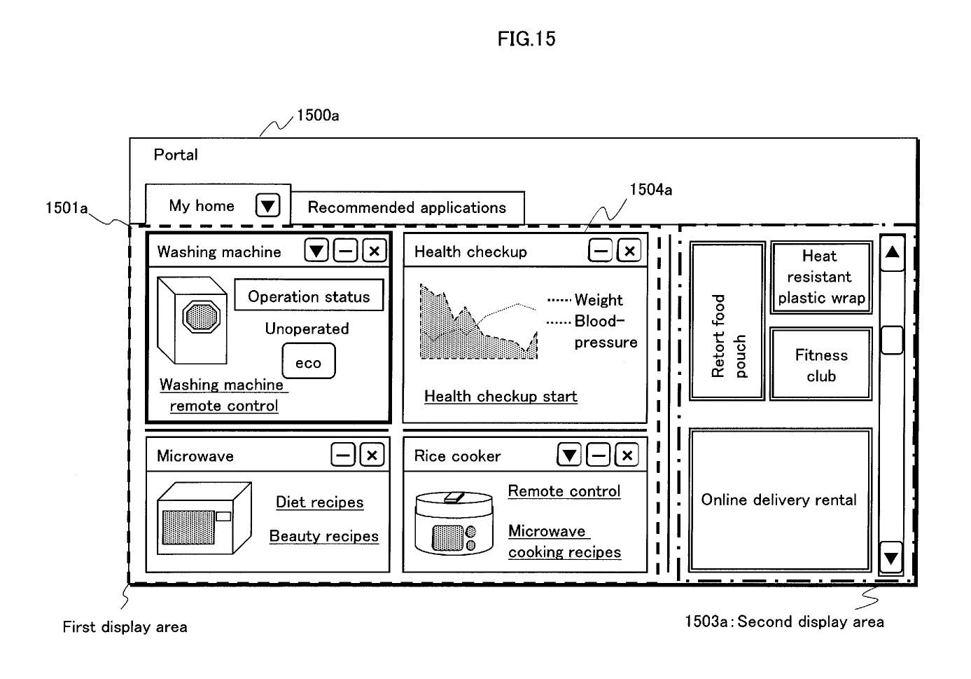

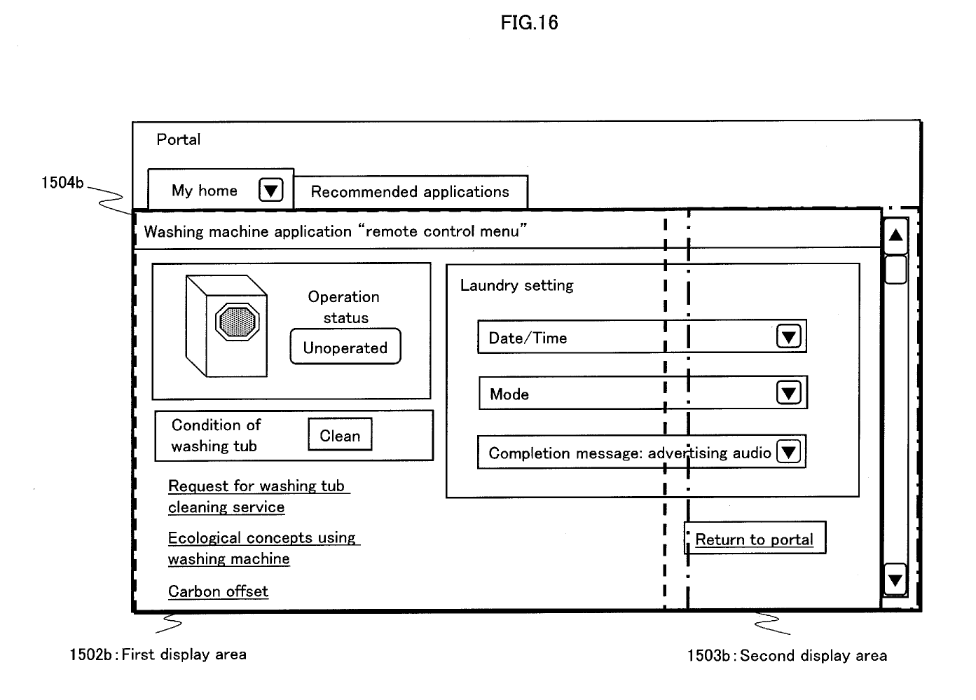

Next, with reference to FIGS. 15 and 16, a description is given of an example in which the lower-level screen of the service application is enlarged in the display area covering the first and the second display areas.

For example, the description is given of a case where the user has focused on and clicked on a washing machine application 1501a by operating the remote control on a portal screen 1500a shown in FIG. 15. Note that it is presumed that the washing machine application 1501a is by default set to be enlarged when the lower-level screen is displayed. In FIG. 15, the advertising application “wash powder” corresponding to the washing machine application 1501a is displayed in the second display area 1503a. Accordingly, the service application display sub-unit 209 changes the display size so that the remote operation menu screen, which is the detailed screen of the washing machine application, is enlarged in the display area covering the first and the second display areas. Thus, as shown in FIG. 16, a remote operation menu 1504b is enlarged in the display area covering a first display area 1502b and a second display area 1503b.

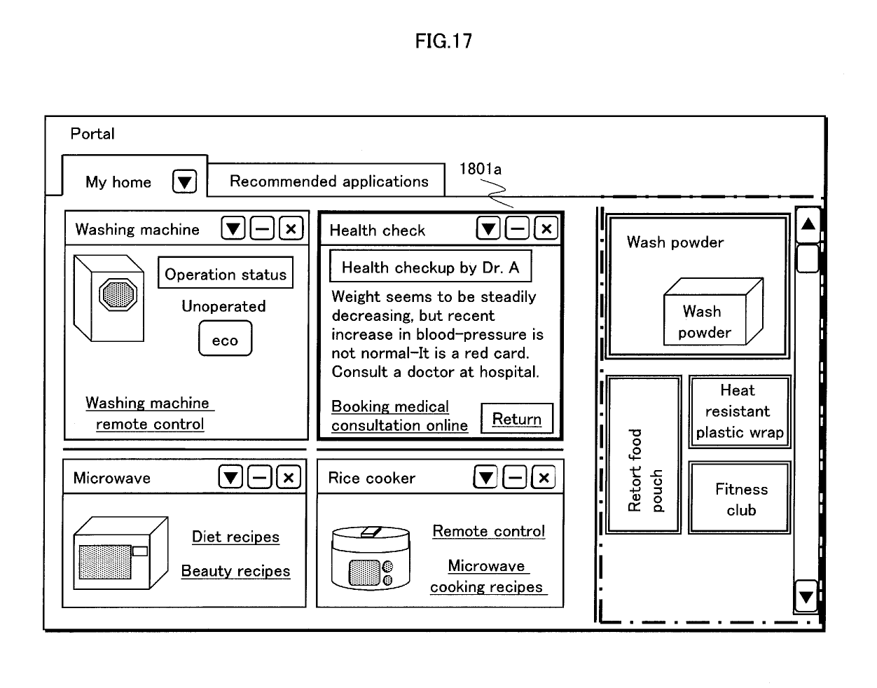

Finally, with reference to FIGS. 3 and 17, a description is given of an example in which the display size is not changed on the occasion of displaying the lower-level screen of the service application.

For example, the description is given of a case where the user has focused on and clicked on the health checkup application 302 by operating the remote control on the portal screen 300 shown in FIG. 3. Note that it is presumed here that the health checkup application 302 is not set by default to be enlarged when the lower-level screen is displayed. The service application display sub-unit 209 displays, for example, a screen 1801a for health checkup shown in FIG. 17, which is a detailed screen of the health checkup application, without changing the display size of the health checkup application 302. At this time, audio of the advertising application “fitness club” corresponding to the health checkup application is output.

[Advertising Audio Output Processing]

FIGS. 9 and 10 are flowcharts showing the procedures of the advertising audio output processing (step S708) of FIG. 7.

The advertising audio output sub-unit 208 reads the life targeting table 210 from the storage unit 111 (step S901). Then, the advertising audio output sub-unit 208 refers to the life targeting table 210 to specify the advertising application corresponding to the service application that the user has focused on and clicked on by operating the remote control (step S902). Subsequently, the advertising audio output sub-unit 208 reads from the storage unit 111 the playback audio selection table corresponding to the specified advertising application (step S903).

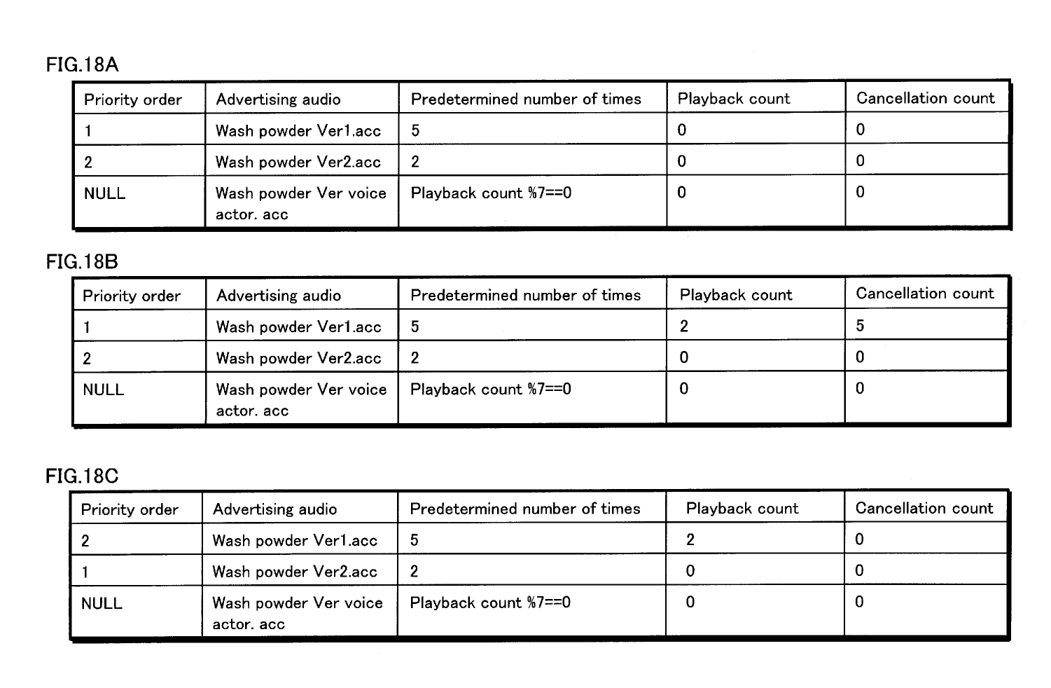

FIGS. 18A, 18B, and 18C show exemplary playback audio selection tables. The playback audio selection tables shown in FIGS. 18A, 18B, and 18C are examples of the tables indicated by the path information piece “file: //nv/ad/lionchan/v1/top2.xml” in the playback audio selection table column 503 described in the life targeting table shown in FIG. 5.

In the playback audio selection tables of FIGS. 18A, 18B, and 18C, the audio files named “wash powder Ver1.acc”, “wash powder Ver2.acc”, and “wash powder Ver voice actor.acc” are described in the rows in the advertising audio column 602 as the audio files of the advertising application corresponding to the priority orders “1”, “2”, and “NULL”, respectively. The predetermined numbers corresponding to the audio files “wash powder Ver1.acc”, “wash powder Ver2.acc”, and “wash powder Ver voice actor.acc” in the advertising audio column are “5”, “2”, and “playback count %7==0”. As mentioned above, as the predetermined number for the advertising audio corresponding to the priority order “NULL”, the condition for playback is described. In FIGS. 18A, 18B, and 18C, the condition for playback is “playback count 7==0”. The condition for playback “playback count 7==0” refers to the condition under which the audio file corresponding to the priority order “NULL” is output when the total playback count is dividable by 7.

In order to specify the audio of the advertising application to be played back from among the playback audio selection table, the advertising audio output sub-unit 208 firstly checks the condition for playback described in a row in the predetermined number of times column corresponding to the priority order “NULL” in the playback audio selection table (step S904). For example, the condition for playback is that “the audio file ‘wash powder Ver voice actor.acc’ is to be output when the total playback count is dividable by 7”.

Then, in order to determine whether or not the condition for playback is satisfied, the advertising audio output unit 208 refers to the playback audio selection table to calculate the total playback count (step S905). The advertising audio output sub-unit 208 then determines whether or not the total playback count satisfies the condition for playback described in the row in the predetermined number of times column corresponding to the priority order “NULL” (step S906).

When the total playback count satisfies the condition for playback (S906: Y), the advertising audio output sub-unit 208 selects the audio file (i.e. “wash powder Ver voice actor.acc” in the example of FIG. 18A) corresponding to the priority order “NULL” as the advertising audio to be output (step S913). The advertising audio output sub-unit 208 also outputs a signal to the audio output unit 113 for instructing the audio output unit 113 to output the selected audio (step S914). Consequently, the selected audio file is output from the speaker of the display device 101. The advertising audio output sub-unit 208 switches the audio output indicator flag to “ON” (step S915). As mentioned above, the audio output indicator flag is provided for the audio output determination sub-unit 207 to check whether or not advertising audio is being output. Furthermore, the advertising audio output sub-unit 208 increments the playback count corresponding to the audio file selected as the advertising audio to be output by “1” in the playback audio selection table (step S916).

On the other hand, when the total playback count does not satisfy the condition for playback (S906: N), the advertising audio output sub-unit 208 selects the audio file having the highest priority order (step S907). For example, in the case of the playback audio selection table shown in FIG. 18A, the advertising audio output sub-unit 208 selects the audio file “wash powder Ver1.acc” having the priority order “1”.

Next, the advertising audio output sub-unit 208 determines whether the cancel count corresponding to the audio file selected in the step S907 is smaller than a prescribed number “n” or not (step S908). As the prescribed number “n”, a value set in advance or a value set by the user may be used, for example. Note that the cancel count is incremented at the time of the transitions from the lower-level screen of the service application to the portal screen which is the top-level screen of the service application, or to other service application in the upper-level/selected screen transition processing whose operation procedures are shown in FIG. 11.

When the cancel counter is greater than the prescribed number “n” (S908: Y), the advertising audio output sub-unit 208 changes the priority order of the audio file selected in the step S907 to the lowest order in the playback audio selection table (step S911), and clears the cancel count corresponding to the audio file selected in the step S907 to 0 (step S912). Then, the processing returns to the step S907. The above processing is performed in order to change the priority order of the output audio file when cancellation (i.e. to stop the audio output) has occurred several times during the playback, so that advertising is provided without making the user bored.

Now, with reference to FIGS. 18B and 18C, a description is given of an example for the change in the priority order and the clearance of cancel count performed for the audio file in the playback audio selection table.

For example, it is assumed that the prescribed number “n” set for the cancel count is “5”. In the playback audio selection table of FIG. 18B, the cancel count for the audio file “wash powder Ver1.acc” having the priority order “1” is “5” which equals to the value “5” of the prescribed number. The advertising audio output sub-unit 208 changes the priority order of the audio file “wash powder Ver1.acc” to “2” which is the lowest order, and clears the corresponding cancel count to 0, as shown in FIG. 18C. The advertising audio output sub-unit 208 also changes the priority order of the audio file “wash powder Ver2.acc” to “1”.

On the other hand, when the cancel count is smaller than the prescribed number “n” (S908: Y), the advertising audio output sub-unit 208 refers to the playback audio selection table to compare the predetermined number with the playback count corresponding to the audio file selected in the step S907 (step S909). Then, the advertising audio output sub-unit 208 determines whether or not the playback count of the audio file selected in the step S907 has reached the predetermined number, based on a result of the comparison made in the step S909 (step S910).

When the playback count corresponding to the audio file selected in the step S907 has not reached the predetermined number (S910: N), the advertising audio output sub-unit 208 outputs a signal to the audio output unit 113 for instructing the audio output unit 113 to output the audio file selected in the step S907 (step S914) Consequently, the selected audio file is output from the speaker of the display device 101. The advertising audio output sub-unit 208 switches the audio output indicator flag to “ON” (step S915). Furthermore, the advertising audio output sub-unit 208 increments the playback count corresponding to the audio file selected in the step S907 by “1” (step S916).

For example, in the playback audio selection table shown in FIG. 18C, regarding the audio file “wash powder Ver2.acc” having the priority order “1”, the playback count value “0” has not reached the predetermined number “2”. Accordingly, the advertising audio output sub-unit 208 selects the audio file “wash powder Ver2.acc” as the advertising audio to be output, and outputs the signal to the audio output unit 113 for instructing the audio output unit 113 to output the audio. Consequently, the audio file “wash powder Ver2.acc” is output from the speaker of the display device 101. The advertising audio output sub-unit 208 switches the audio output indicator flag to “ON”, and increments the playback count of the audio file “wash powder Ver2.acc” selected as the advertising audio to be output by 1.

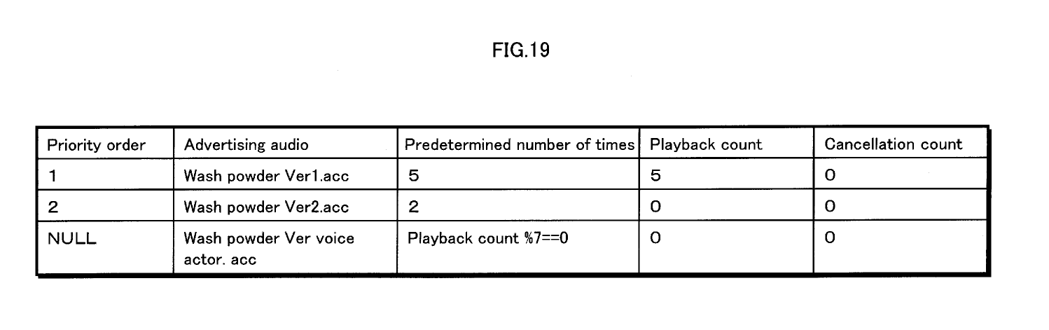

On the other hand, when the playback count corresponding to the audio file selected in the step S907 has reached the predetermined number (S910: Y), processing of step S1001 in FIG. 10 is performed. The advertising audio output sub-unit 208 changes the priority order of the selected audio file to the lowest order in the playback audio selection table (step S1001). For example, in the playback audio selection table shown in FIG. 19, the playback count for the audio file “wash powder Ver1.acc” is “5” which equals to the value “5” of the prescribed number. In this case, the advertising audio output sub-unit 208 changes the priority order of the audio file “wash powder Ver1.acc” to “2”, and changes the priority order of the audio file “wash powder Ver2.acc” to “1”.

Subsequently, the advertising audio output sub-unit 208 determines whether the respective playback counts corresponding to all the audio files described in the playback audio selection table have reached the predetermined number (step S1002).

When the playback count of even a single audio file has not reached the predetermined number (S1002: N), the processing of the step S907 is performed.

On the other hand, when the respective playback counts corresponding to all the audio files have reached the predetermined number (S1002: Y), the advertising audio output sub-unit 208 determines whether or not advertising audio should be output (step S1003). When it is determined that advertising audio should not be output (S1003: N), the advertising audio output sub-unit 208 does not output advertising audio (step S1005). On the other hand, when it is determined that advertising audio should be output (S1003: Y), the advertising audio output sub-unit 208 determines whether or not the priority orders described in the playback audio selection table should be changed (step S1004).

When it is determined that the priority orders should not be changed, (S1004: N), the advertising audio output sub-unit 208 clears the respective playback counts corresponding to all the audio files to 0 in the playback audio selection table (step S1006). Subsequently, the processing of the step S907 shown in FIG. 9 is performed. On the other hand, when it is determined that the priority orders should be changed (S1004: Y), the advertising audio output sub-unit 208 randomly rewrites the respective priority orders corresponding to all the audio files in the playback audio selection table (step S1007). The advertising audio output sub-unit advertising audio output unit 208 also clears the respective playback counts corresponding to all the audio files to 0 in the playback audio selection table (step S1008). Subsequently, the processing of the step S907 shown in FIG. 9 is performed.

Meanwhile, in the rewriting of the priority orders, the priority orders corresponding to all the audio files including the audio file having the priority order “NULL” may be randomly rewritten. Moreover, the condition for playback described in the row in the predetermined number of times column corresponding to the priority order “NULL” may also be changed.

Furthermore, the priority orders are not necessarily rewritten by a method of randomly rewriting the priority orders corresponding to the audio files, and the rewriting method is not particularly limited. A possible rewriting method is to raise the priority order of the audio file having the lowest priority order to the highest order, and to lower the priority order of each of the remaining audio files by 1.

Furthermore, the user may make the following settings in the control terminal device 100 in advance: (1) a setting for the condition about whether or not audio of advertising application should be output when the respective playback counts for all the audio files have reached the predetermined number; and (2) a setting for the condition about whether or not the priority orders should be changed, The user may also make the above settings everytime the control terminal device 100 prompts the user to input the settings for the conditions. Alternatively, the above settings for the conditions may be assigned to the advertising applications as the attribute information pieces at the time of distribution of the advertising applications.

As mentioned above, when the service application corresponding to one of the home appliances is selected, the audio of the advertising application corresponding to the selected service application is output if audio of any advertising application is not being output. This prevents a situation where audio of a plurality of advertising applications are output to interfere with each other.

Furthermore, audio is output for the advertising application corresponding to the service application that the user has focused on and clicked on from among the service applications associated with the respective home appliances. This allows the audio output by appropriately selecting the advertising application corresponding to the service application associated with the home appliance in which the user is probably interested, thereby greatly increasing the advertising effectiveness.

[Upper-Level/Top-Level Screen Transition Processing]

FIG. 11 is a flowchart showing procedures of the upper-level/top-level screen transition processing of FIG. 7 (step S711). Note that the processing shown in the flowchart of FIG. 11 is performed in a state where the user has transitioned to the lowest-level screen by operating the service application.

It is assumed that the user is currently using the service application in the lowest-level screen of the service application by operating the service application. The input information processing sub-unit 204 waits for the user operation using the remote control 102, and receives the input information 201 regarding the user operation using the remote control 102 (step S1101). The input information processing sub-unit 204 then determines whether or not the user operation using the remote control 102 is an operation relating to a power-off (step S1102).

When the user operation using the remote control is the operation relating to the power-off (S1102: Y), the audio output determination sub-unit 207 refers to the value of the audio output indicator flag to determine whether or not the advertising audio is being output (step S1103).

When the advertising audio is being output (S1103: Y), the audio output determination sub-unit 207 outputs a signal to the advertising audio output sub-unit 208 for instructing the advertising audio output sub-unit 208 to rewrite the playback audio selection table. In response to the signal, the advertising audio output sub-unit 208 increments the cancel count corresponding to the audio file being output by “1” (step S1104). The control unit 111 turns the control terminal device 100 off (step S1105). On the other hand, when the advertising audio is not being output (S1103: N), the control unit 111 immediately turns the control terminal device 100 off (step S1105).

Meanwhile, when the user operation using the remote control is not the operation relating to the power-off (S1102: N), the input information processing sub-unit 204 determines whether the user operating using the remote control 102 has been made by focusing on and clicking on the “return to portal” button (that enables the user to return to the portal screen which is the top-level screen of the service application) by operating the remote control (step S1106).

When the user operation using the remote control is the operation relating to the returning to the portal screen (S1106: Y), the audio output determination sub-unit 207 refers to the value of the audio output indicator flag to determine whether or not the advertising audio is being output (step S1107).

When the advertising audio is being output (S1107: Y), the advertising audio output sub-unit 208 outputs a signal to the audio output unit 113 for instructing the audio output unit 113 to stop the advertising audio being output (step S1108). Consequently, the audio output unit 113 stops the advertising audio being output.

The audio output determination sub-unit 207 outputs a signal to the advertising audio output sub-unit 208 for instructing the advertising audio output sub-unit 208 to rewrite the playback audio selection table. In response to the signal, the advertising audio output sub-unit 208 increments the cancel count corresponding to the stopped audio file by “1” in the playback audio selection table (step S1109). The service application display sub-unit 209 displays the portal screen (step S1110). According to the above steps, when it is instructed to return from the lower-level screen to the top-level screen, the output of the advertising audio is stopped if the audio (i.e. advertising audio) of the advertising application is being output. More specifically, the audio output for the advertising audio which is being output is stopped under the assumption that the user is no longer interested in the service application associated with the home appliance corresponding to the advertising audio which is being output because the user wishes to return to the top-level screen. This prevents a situation where the audio is continuously output for the advertising application corresponding to the service application associated with the home appliance in which the user is no longer interested. Accordingly, when the user focuses on and clicks on another service application by operating the remote control, the audio of the advertising application corresponding to the other service application is output.

On the other hand, when the advertising audio is not being output (S1107: N), the service application display sub-unit 209 displays the portal screen (step S1110).

When the user operation using the remote control is not the operation relating to the return to the portal screen (S1106: N), the input information processing sub-unit 204 determines whether the user operating using the remote control 102 has been made by focusing on and clicking on the “return” button (that enables the user to return to a screen one level upper than the current lower-level screen) by operating the remote control (step S1111).

When the user operating using the remote control has been made to return to the screen one level upper than the current lower-level screen (S1111: Y), the input information processing sub-unit 204 instructs the service application display sub-unit 209 to display the screen one level upper than the current lower-level screen of the service application (step S1112). Subsequently, the service application display sub-unit 209 displays the screen one level upper than the current lower-level screen of the service application, and the advertising audio output sub-unit 208 performs the advertising audio output processing corresponding to the service application (step S1113). The processing of the step S1113 corresponds to the display/advertising audio output processing of FIG. 7.

According to the above step, when it is instructed to return from the lower-level screen being displayed to the screen one level upper than the lower-level screen, the audio output of the advertising application is continued. More specifically, the audio output of the advertising application is continued under the assumption that the user is still interested in the service applications associated with the identical home appliance. By this, the audio output is continued for the advertising application corresponding to the service application associated with the home appliance in which the user is interested. As a result, advertising with an appropriate content is realized.

When the user operation using the remote control has not been made to return to the screen one level upper than the current lower-level screen (S1111: N), the audio output determination sub-unit 207 refers to the value of the audio output indicator flag to determine whether or not the advertising audio is being output (step S1114). When the advertising audio is not being output (S1114: N), the step S701 of FIG. 7 is performed. When the advertising audio is being output (S1114: Y), the advertising audio output sub-unit 208 outputs a signal to the audio output unit 113 for instructing the audio output unit 113 to stop the advertising audio being output (step S1115). Consequently, the audio output unit 113 stops the advertising audio being output. In response to the signal, the advertising audio output sub-unit 208 increments the cancel count corresponding to the stopped audio file by “1” in the playback audio selection table (step S1116). Meanwhile, the case where the user operation using the remote control has not been made to return to the screen one level upper than the current lower-level screen happens when the user has moved directly from one service application whose size has not been changed to another service application, for example.

In this case, the advertising audio which is being output is stopped under the assumption that the user is no longer interested in the service application associated with the home appliance corresponding to the advertising audio which is being output. This prevents the situation where the audio is continuously output for the advertising application corresponding to the service application associated with the home appliance in which the user is probably no longer interested. Accordingly, when the user focuses on and clicks on another service application by operating the remote control, the audio of the advertising application corresponding to the other service application is output.

The following describes an example of transitions of screen display in response to the upper-level/top-level screen transition processing shown in FIG. 11, with reference to FIGS. 20, 3, 17, and 21.

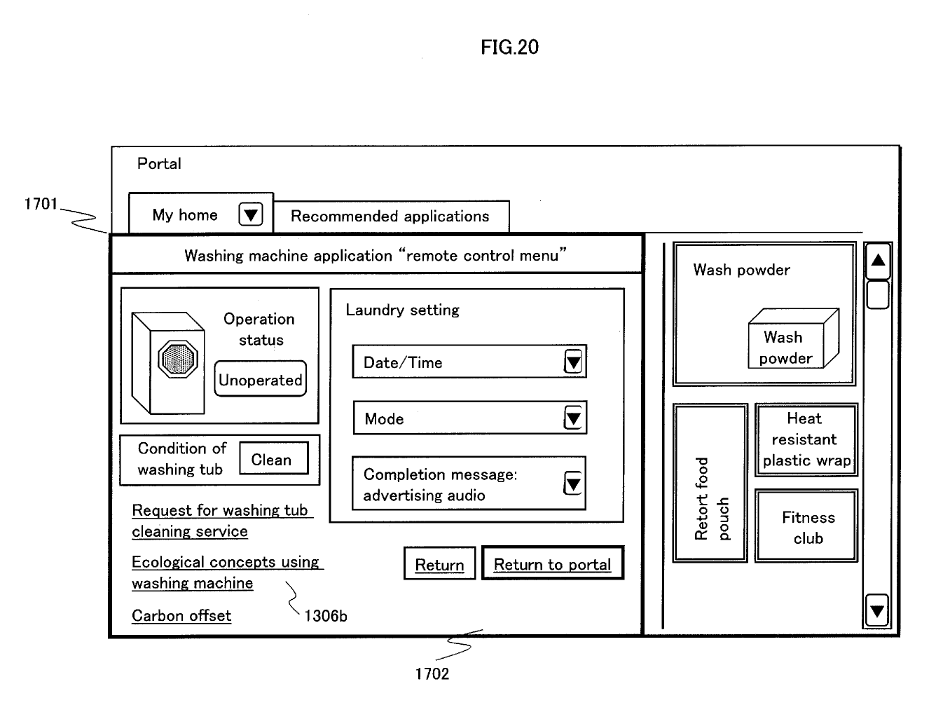

To begin with, with reference to FIGS. 20 and 3, a description is given of an example of transitions of screen display for returning from the lower-level screen to the portal screen which is the top-level screen of the service application.

The description is given of a case where the user focuses on and clicks on the “return to portal” button 1702 by operating the remote control on the remote operation menu screen 1701 of the washing machine application shown in FIG. 20. In response to the user operation, the display screen transitions from the screen of FIG. 20 to the portal screen 300 shown in FIG. 3. In this case, when the advertising audio is being output, the audio playback is stopped, while the display screen returns to the portal screen 300 shown in FIG. 3. When the advertising audio is not being output, only the display of the service application is changed, that is to say, the display screen returns to the portal screen 300 shown in FIG. 3. The control unit 112 stops the audio of the advertising application even in the middle of the output under the assumption that the user is no longer interested in the service application operated by the user, but is interested in another service application because the user has focused on and clicked on the “return to portal” button 1702 by operating the remote control.

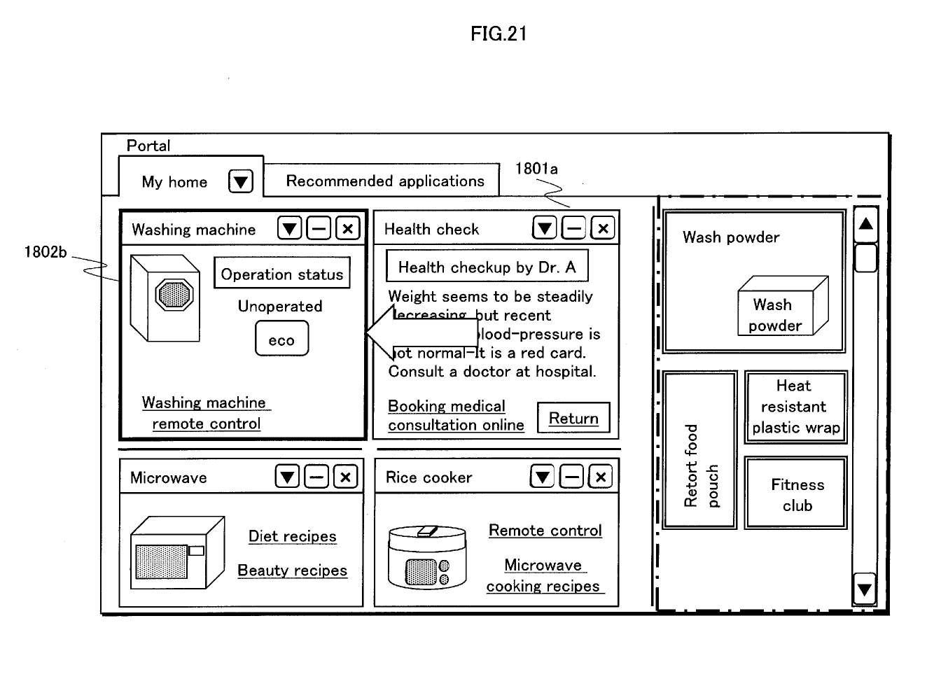

Next, with reference to FIGS. 17 and 21, a description is given of an example of the transition directly from the service application whose display size has not been changed to another service application.

The description is given of a case where the user is currently utilizing the health checkup application 1801a whose display size has not been changed, by focusing on and clicking on the health checkup application 1801a by operating the remote control, as shown in FIG. 17. In this case, when the user drags the cursor to a washing machine application 1802b by operating the remote control 102, the advertising audio of the advertising application “fitness club” corresponding to the health checkup application is stopped if the advertising audio is being output. On the other hand, if the advertising audio of the advertising application “fitness club” corresponding to the health checkup application is not being output, the cursor of the remote control is only dragged to the washing machine application.

<Advertising Audio Control Processing (Completion of Home Appliance Operation)>

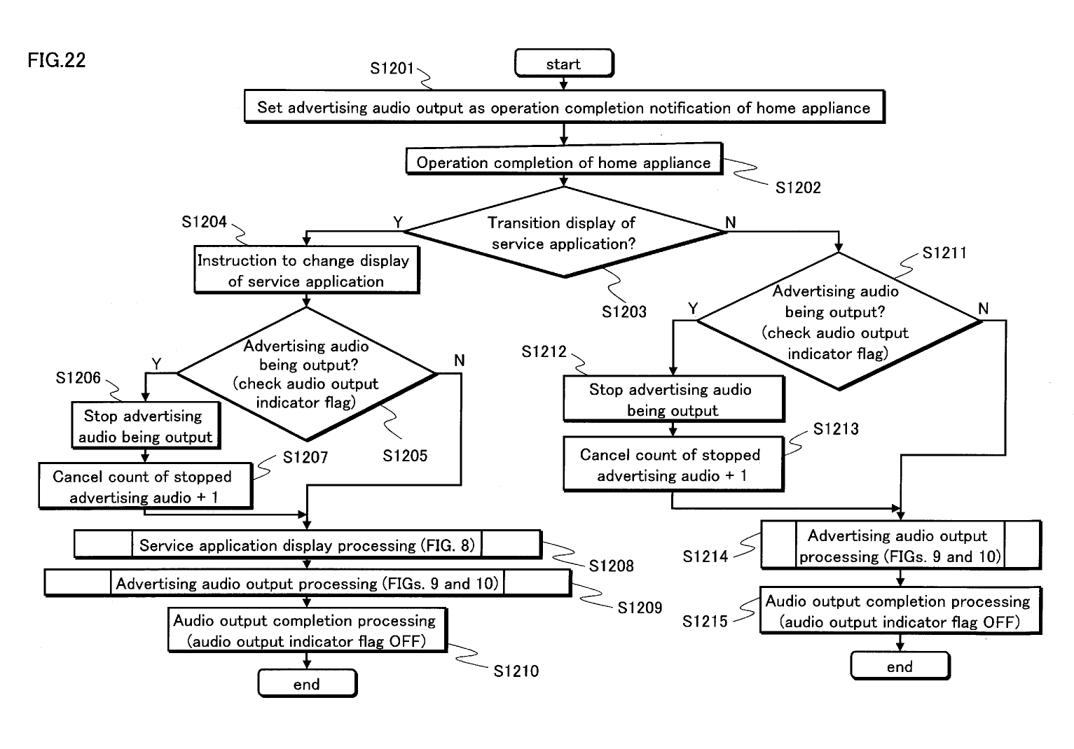

FIG. 22 is a flowchart showing procedures of the advertising audio control processing (operation completion notification) performed by the control unit 112 of FIG. 2. The advertising audio control processing (operation completion notification) refers to processing of sending the user an operation completion notification of a home appliance set up by the service application, with use of the audio of the advertising application.

The user performs an operation for setting, as the operation completion notification of a home appliance, the audio (i.e. advertising audio) of the advertising application corresponding to the service application associated with the home appliance, by using the remote control 102. In response to the user setting, the control unit 112 makes a setting so that the advertising audio is output as the operation completion notification of the home appliance (step S1201). By setting the audio (i.e. advertising audio) of the advertising application to be output as the operation completion notification, the audio is output for the advertising application corresponding to the service application associated with the home appliance whose operation has been completed as the operation completion notification, even when the user is operating another service application.

The input information processing sub-unit 204 waits for the operation completion of the home appliance which has been set by the user so that the corresponding advertising audio is output as the operation completion notification. Once the operation of the home appliance has been completed, the input information processing sub-unit 204 receives the input information 201 indicating the operation completion via the home appliance control unit 115 (step S1202).

Based on the input information 201 indicating the operation completion, the input information processing sub-unit 204 determines whether or not to transition the display of the service application (step S1203). Note that whether or not to transition the display of the service application at the operation completion is determined according to condition setting made for the respective service applications. The condition setting may be made in advance in the control terminal device 100, or simultaneously with the user setting to set the advertising audio to be output as the operation completion notification.

When it is determined that the display of the service application is to be transitioned (S1203: YES), the input information processing sub-unit 204 outputs a signal to the service application display sub-unit 209 for instructing the service application display sub-unit 209 to change the display of the service application (step S1204). The audio output determination sub-unit 207 refers to the value of the audio output indicator flag to determine whether or not the advertising audio is being output (step S1205).

When the advertising audio is not being output (S1205: N), the service application processing sub-unit 209 performs the service application display processing (step S1208). At the same time, the advertising audio output sub-unit 208 performs the advertising audio output processing (step S1209). Once the audio output of the advertising application has been completed, the advertising audio output sub-unit 208 switches the audio output indicator flag to “OFF” (step S1210). Note that the service application that the user has focused on and clicked on by operating the remote control in the processing of FIG. 8 is replaced with the service application corresponding to the home appliance whose operation has been completed in the service application display processing of the step S1208. Note also that the service application that the user has focused on and clicked on by operating the remote control in the processing of FIGS. 9 and 10 is replaced with the service application corresponding to the home appliance whose operation has been completed in the advertising audio output processing of the step S1209.

On the other hand, when the advertising audio is being output (S1205: Y), the advertising audio output sub-unit 208 outputs a signal to the audio output unit 113 for instructing the audio output unit 113 to stop the advertising audio being output (step S1206). Consequently, the audio output unit 113 stops the advertising audio being output. In response to the signal, the advertising audio output sub-unit 208 increments the cancel count corresponding to the stopped audio file by “1” in the playback audio selection table (step S1207). Subsequently, the service application processing unit 209 performs the service application display processing (step S1208). At the same time, the advertising audio output sub-unit 208 performs the advertising audio output processing (step S1209). Once the audio output of the advertising application has been completed, the advertising audio output sub-unit 208 switches the audio output indicator flag to “OFF” (step S1210).

On the other hand, when it is not determined that the display of the service application is to be transitioned (S1203: NO), the audio output determination sub-unit 207 refers to the value of the audio output indicator flag to determine whether or not advertising audio is being output (step S1211).

When the advertising audio is not being output (S1211: N), the advertising audio output sub-unit 208 performs the advertising audio output processing (step S1214). Once the audio output of the advertising application has been completed, the advertising audio output sub-unit 208 switches the audio output indicator flag to “OFF” (step S1215). Note that the service application that the user has focused on and clicked on by operating the remote control in the processing of FIGS. 9 and 10 is replaced with the service application corresponding to the home appliance whose operation has been completed in the advertising audio output processing of the step S1214.

When the advertising audio is being output (S1211: Y), the audio output determination sub-unit 207 outputs a signal to the audio output unit 113 for instructing the audio output unit 113 to stop the advertising audio being output (step S1212). Consequently, the audio output unit 113 stops the advertising audio being output. In response to the signal, the advertising audio output sub-unit 208 increments the cancel count corresponding to the stopped audio file by “1” in the playback audio selection table (step S1213). Then, the advertising audio output sub-unit 208 performs the advertising audio output processing (step S1214). Once the audio output of the advertising application has been completed, the advertising audio output sub-unit 208 switches the audio output indicator flag to “OFF” (step S1215).

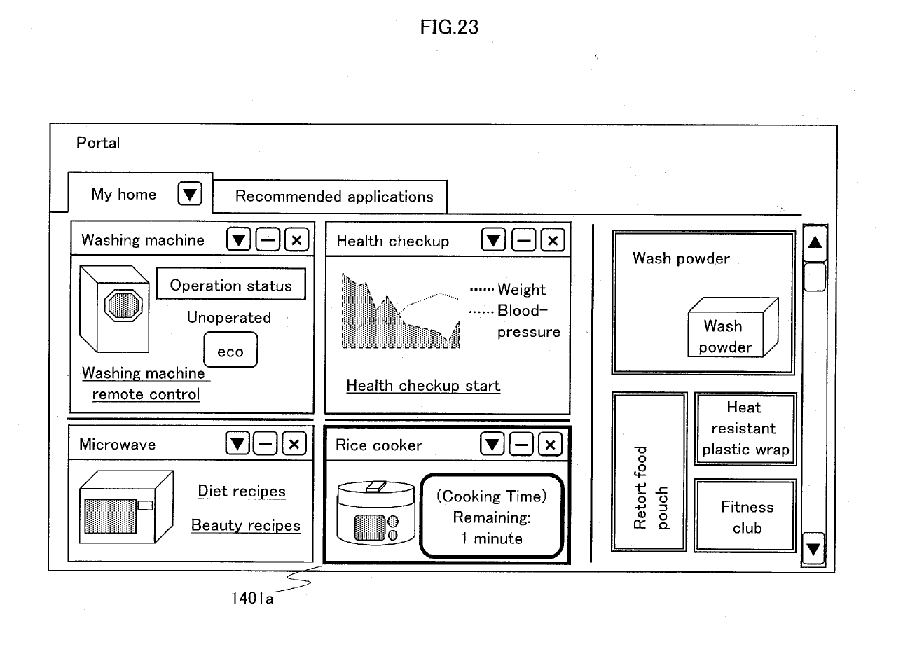

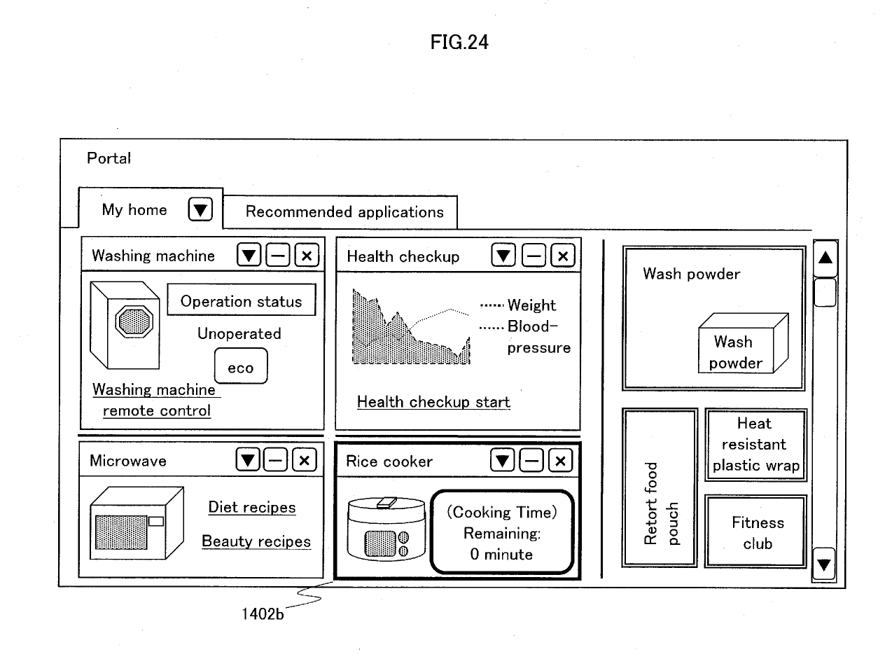

The following describes an example of transitions of screen display in response to the advertising audio control processing (i.e. the operation completion notification of a home appliance) shown in FIG. 22, with reference to FIGS. 23 and 24.

The description is given of a case where the user has set the advertising audio to be output as the operation completion notification of the rice cooker application. Note that the rice cooker application herein refers to a service application in which the display is not transitioned at the operation completion. The rice cooker application corresponds to the advertising application “retort food pouch”.

Once operation associated with a rice cooker application 1401a of FIG. 23 has been completed, the message “(Cooking Time) Remaining: 0 minute” is displayed on a rice cooker application 1402b as shown in FIG. 24 to notify the user of the operation completion. In this case, when the audio of the advertising application corresponding to the rice cooker application or any other advertising application is being output, the audio of the advertising application is stopped. Instead, the audio of the advertising application “retort food pouch” corresponding to the rice cooker application is output. When the advertising audio is not being output at the operation completion of the rice cooker application, the advertising audio of the advertising application “retort food pouch” is immediately output. Thus, the control unit 112 stops the audio of the advertising application being output, and newly outputs the audio of the advertising application “retort food pouch” corresponding to the rice cooker application. By doing so, the control unit 112 is able to notify the user of the operation completion accurately. Furthermore, when the user waits for the operation completion, this means that the user focuses their attention on the audio indicating the operation completion. Accordingly, effectiveness of the advertising is increased.

According to the above steps, in response to the operation completion notification with respect to a home appliance, the lower-level screen of the service application associated with the home appliance is displayed. In conjunction of this, the audio of the corresponding advertising application is output. Accordingly, the audio of the advertising application serves to notify the user of the operation completion of the home appliance, in addition to its conventional function as advertising audio. As a result, with respect to the home appliance that the user is currently using, advertising associated with the home appliance is provided. This provides effects to both the advertiser and the user. That is to say, the advertiser is enabled to provide advertising at appropriate timing to appeal to the user. On the other hand, the user is enabled to easy imagine the home appliance associated with the advertising audio, and easy acknowledge the operation completion of the home appliance.

<<Supplementary Remarks>>

The present invention is not limited to the above embodiment, and may be implemented in any embodiment that aims to achieve the objective the present invention and other objectives relating thereto or associated therewith. For example, the following modifications are also within the scope of the present invention.

(1) Although in the embodiment the control terminal device is the digital recorder, the present invention is not limited to the embodiment. The control terminal device may be other home appliances having a display device, such as a TV, a mobile phone, and a personal computer.

(2) Although in the embodiment the number of the home appliances at home is four, the number of the home appliances at home may be three or five, and not limited to a particular number.

(3) The control terminal device 100 in the embodiment may receive, from the service application server 107 via the internet NW2, the service applications which are updated as needed, and store the received service applications in the storage unit 111. The control terminal device 100 in the embodiment may also receive, from the application server 108 via the internet NW2, the advertising applications which are updated as needed, and store the received advertising application in the storage unit 111.

(4) Although in the embodiment the service applications are the washing machine application, the health checkup application, the microwave application, and the rice cooker application, the service applications are not limited to these applications. Furthermore, although the advertising applications are described as the applications for the wash powder, the heat resistant plastic wrap, the retort food pouch, and the fitness club, the advertising applications are not limited to these applications.

(5) Although in the embodiment the washing machine application is associated with the advertising application for the wash powder with the keyword “wash powder” at the time of creating the life targeting table, the present invention is not limited to this.

(6) Although in the embodiment the condition for playback of the audio file corresponding to the priority order “NULL” is set to be that “the total playback count is dividable by 7”, the present invention is not limited to this.

(7) Although in the embodiment the format of the playback audio selection table is xml (Extensible Markup Language), the format of the playback audio selection table is not limited to this, and various formats may be used as the format of the playback audio selection table. Furthermore, as the format of the life targeting table, various formats, such as xml, and csv (Comma Separated Values), may be used.

(8) Although in the embodiment the user selects one service application, and audio is output for the advertising application corresponding to the selected service application, it is also possible to change the display of the advertising application simultaneously with the audio output of the advertising application.

(9) In the description of FIG. 7 in the embodiment, the life targeting management sub-unit 206 has already created the life targeting table and the playback audio selection table. However, the life targeting management sub-unit 206 may create the life targeting table and the playback audio selection table while the control unit 112 is operating. The life targeting management sub-unit 206 may also create the life targeting table and the playback audio selection table when the control terminal device 100 acquires a new service application and advertising application from the service application server 107 and the application server 108 shown in FIG. 1.

(10) In the embodiment, as the operation completion notification of the home appliance, the advertising audio of the advertising application corresponding to the service application associated with the home appliance is used. However, the present invention is not limited to this, and the advertising audio of the advertising application may also be used as an operation start notification or an external input notification of the home appliance. For example, it is possible to utilize a service application associated with an interphone so that the advertising application corresponding to the service application is used as a notification of a visitor to the home.

(11) The operation procedures shown in the flowcharts of FIGS. 7, 11, and 22 may be described as a computer program which is recorded on computer-readable recording media to be distributed.

(12) The control unit described mainly in the embodiment is not limited to software running on a CPU or an MPU, and may be configured as hardware. In this case, the control unit may be typically realized as an LSI (Large Scale Integration) which is an integrated circuit. Each component of the above embodiment may be made into a single and separate chip, or may be made into a single chip including a portion or all portions thereof.

The LSI referred to here is also called an IC (Integrated Circuit), a system LSI, a super LSI, or an ultra LSI depending on the degree of integration.

Also, the integration is not limited to LSI implementation, but instead may be realized by a dedicated or a general-purpose circuit. A FPGA (Field Programmable Gate Array) or a reconfigurable processor in which the connection and settings of circuit cells in the LSI can be restructured after LSI manufacture can also be used.

Furthermore, if integration technology is developed that replaces LSIs due to the progress in semiconductor technology and other derivative technologies, integration of functional blocks using this technology is naturally possible. For example, the application of biotechnology is a possibility.

### INDUSTRIAL APPLICABILITY

The present invention can be used in various devices having a display function and a function of outputting advertising audio to a user.

### REFERENCE SIGNS LIST

100 control terminal device
101 display device
102 remote control
103 to 106 home appliance
107 service application server
108 application server
109 communication interface unit
110 interface unit
111 storage unit
112 control unit
113 audio output unit
114 image output unit
115 home appliance control unit
204 input information processing sub-unit
205 application/advertisement identification sub-unit
206 life targeting management sub-unit
207 audio output determination sub-unit
208 advertising audio output sub-unit
209 service application display sub-unit

1. An advertising audio control device to which an output device and home appliances are connected, the output device having a display function and an audio output function, the advertising audio control device comprising:
a storage unit storing service applications and advertising applications, each service application corresponding to one or more of the advertising applications and associated with a different one of the home appliances; and
a control unit operable to (i) cause the output device to display the service applications stored in the storage unit on a display panel of the output device, (ii) select one service application from among the displayed service applications, (iii) detect an advertising application corresponding to the selected service application from among the advertising applications stored in the storage unit, and (iv) cause the output device to output audio of the detected advertising application.

2. The advertising audio control device of claim 1, wherein
the service applications stored in the storage unit are displayed, on the display panel, in a top-level screen of a plurality of screens having a hierarchical display structure, and
upon receiving, on the top-level screen, an instruction to display a lower-level screen with respect to one of the displayed service applications, the control unit selects the one of the displayed service applications as the one service application.

3. The advertising audio control device of claim 2, wherein
the instruction is provided using a remote control unit for operating the output device.

4. The advertising audio control device of claim 2, wherein
the instruction is an operation completion notification of one of the home appliances, and
upon receiving the operation completion notification, the control unit selects a service application associated with the one of the home appliances as the one service application.

5. The advertising audio control device of claim 2, wherein
the top-level screen includes a first display area and a second display area,
the control unit causes the output device to display, (i) in the first display area, the service applications stored in the storage unit, and (ii) in the second display area, advertising applications corresponding to at least one of the displayed service applications, and
upon receiving the instruction to display the lower-level screen with respect to the one of the displayed service applications, the control unit further causes the output device to enlarge the lower-level screen in the first display area when the corresponding advertising application is displayed in the second display area.

6. The advertising audio control device of claim 5, wherein
upon receiving the instruction to display the lower-level screen with respect to the one of the displayed service applications, the control unit further causes the output device to enlarge the lower-level screen in a display area covering the first display area and the second display area when the corresponding advertising application is not displayed in the second display area.

7. The advertising audio control device of claim 1, further comprising:
an audio storage unit storing one or more audio files for each advertising application, the one or more audio files being assigned with priority levels, wherein
the control unit detects one audio file from among the audio files stored for the advertising application corresponding to the specified service application in the audio storage unit in accordance with the priority levels, and causes the output device to output audio for the detected audio file.

8. The advertising audio control device of claim 2, wherein
after the lower-level screen is displayed, the control unit causes the output device to stop the audio output upon receiving an instruction to return from the lower-level screen to the top-level screen.

9. The advertising audio control device of claim 2, wherein
after the lower-level screen is displayed, the control unit causes the output device to continue the audio output even upon receiving an instruction to return from the lower-level screen to a screen which is one level upper than the lower-level screen.

10. The advertising audio control device of claim 2, wherein
after the lower-level screen is displayed, the control unit causes the output device to stop the audio output upon receiving an instruction to display any service application other than the specified service application.

11. An integrated circuit mounted on an apparatus to which an output device and home appliances are connected, the output device having a display function and an audio output function, the apparatus including a storage unit storing service applications and advertising applications, each service application corresponding to one or more of the advertising applications and associated with a different one of the home appliances, the integrated circuit comprising:
a control unit operable to (i) cause the output device to display the service applications stored in the storage unit on a display panel of the output device, (ii) select one service application from among the displayed service applications, (iii) detect an advertising application corresponding to the selected service application from among the advertising applications stored in the storage unit, and (iv) cause the output device to output audio of the detected advertising application.

12. An advertising audio control method used in an apparatus to which an output device and home appliances are connected, the output device having a display function and an audio output function, the apparatus including a storage unit storing service applications and advertising applications, each service application corresponding to one or more of the advertising applications and associated with a different one of the home appliances, the advertising audio control method comprising the steps of:
causing the output device to display the service applications stored in the storage unit on a display panel of the output device;
selecting one service application from among the displayed service applications;
detecting an advertising application corresponding to the selected service application from among the advertising applications stored in the storage unit; and
causing the output device to output audio of the detected advertising application.

13. An advertising audio control program used in an apparatus to which an output device and home appliances are connected, the output device having a display function and an audio output function, the apparatus including a storage unit storing service applications and advertising applications, each service application corresponding to one or more of the advertising applications and associated with a different one of the home appliances, the advertising audio control program comprising the steps of:
causing the output device to display the service applications stored in the storage unit on a display panel of the output device;
selecting one service application from among the displayed service applications;
detecting an advertising application corresponding to the selected service application from among the advertising applications stored in the storage unit; and
causing the output device to output audio of the detected advertising application.

14. A computer-readable recording medium storing therein an advertising audio control program used in an apparatus to which an output device and home appliances are connected, the output device having a display function and an audio output function, the apparatus including a storage unit storing service applications and advertising applications, each service application corresponding to one or more of the advertising applications and associated with a different one of the home appliances, the advertising audio control program comprising the steps of:
causing the output device to display the service applications stored in the storage unit on a display panel of the output device;
selecting one service application from among the displayed service applications;
detecting an advertising application corresponding to the selected service application from among the advertising applications stored in the storage unit; and
causing the output device to output audio of the detected advertising application.
